(19) United States
(12) Patent Application Publication
(10) Pub. No.: US 2026/0119407 A1
(43) Pub. Date: Apr. 30, 2026

(54) CACHE MANAGEMENT AT A COMPUTER FOR A REMOTE STORAGE SYSTEM

(71) Applicant: VMware LLC, Palo Alto, CA (US)

(72) Inventors: Wenguang Wang, Santa Clara, CA (US); Robert Timothy Johnson, Scotts Valley, CA (US); Sazzala Venkata Reddy, Los Altos, CA (US)

(21) Appl. No.: 18/929,339

(22) Filed: Oct. 28, 2024

(51) Int. Cl. G06F 13/16; G06F 12/02

(52) U.S. Cl. CPC G06F 12/0895; G06F 12/123; G06F 2212/304

(57) ABSTRACT

An example computer includes: a hardware platform including a memory, a central processing unit (CPU) having a first cache for the memory, and a storage device, the storage device configured to store a second cache for a remote storage system accessible by the computer over a network; first software executing on the hardware platform and configured to maintain metadata in the memory for the second cache, the metadata including a table having rows, each of the rows controlling multiple entries in the second cache, each of the rows having a first size, the first size less than or equal to a second size of entries in the first cache; and second software executing on the hardware platform and configured to issue a read or write transaction for an object managed by the remote storage system.

### BACKGROUND

A computer can store data in secondary storage. A computer may be an electronic device for storing and processing data. Secondary storage may be storage indirectly accessed by a central processing unit (CPU) of a computer through an input/output (IO) subsystem. Well known and widely used IO subsystems include Serial Advanced Technology Attachment (SATA), Nonvolatile Memory Express (NVMe). The IO subsystem may be connected to the computer via Peripheral Component Interconnect Express (PCIe), Compute Express Link (CXL), or network such as Fibre Channel, Ethernet, INFINIBAND via protocols such as NVMe-over-Fabric where “Fabric” could be transmission control protocol (TCP), remote direct memory access (RDMA), RDMA over Ethernet (ROCE) or other network protocols. Primary storage in a computer may be storage directly accessed by the CPU through data and address busses (e.g., random-access memory (RAM)). A storage device may be a device that provides secondary storage for a computer. Example storage devices include hard disk drives (HDDs) and solid-state drives (SSDs). Memory may be device(s) that provide primary storage for a computer. A well-known and widely used device for memory in a computer is dynamic random-access memory (DRAM).

A computer can include one or more storage devices. A computer can also access storage device(s) remote from the computer using a network. A network may be a system that connects computers. A remote storage system may be a system having storage devices accessed by computer(s) over a network. A remote storage system may be implemented by a computer having storage devices or a group of such computers (sometimes referred to as a cluster of computers). Software executing on a computer or cluster of computers can utilize the remote storage system for storing data. In this context, the computer(s) using the remote storage system can be referred to as client computer(s) (e.g., where the computers of the remote storage system can be referred to as server computers that provide a service to client computers in the form of secondary storage).

For software in a client computer, accessing a remote storage system can incur more latency than accessing a storage device in the client computer (e.g., due to the intervening network). Thus, the client computer can include a cache for the remote storage system implemented using storage device(s) in the client computer. A cache may be temporary storage (e.g., storage used to store something temporarily). A cache for a remote storage system can store, on a temporary basis, data stored by or to be stored by the remote storage system. A cache can have less capacity than the remote storage system (e.g., can store less data, typically orders of magnitude less data). Cache management may be a process of deciding which data to store in the cache and which data to remove from the cache (referred to as evicting data from the cache). When reading data stored by remote storage system, if a copy of the data is resident in the cache at the client computer, the latency of the read transaction can be reduced.

A storage manager in the client computer can maintain metadata for controlling the cache. Metadata may be a set of data that describes other data. Metadata for the cache can control the cache by facilitating access to data in the cache and implementing an algorithm for data eviction and replacement (referred to as a cache replacement algorithm). For example, software in the client computer can request some data from the remote storage system (e.g., a read transaction). The storage manager in the client computer can first search the metadata to determine if the requested data is in the cache and, if so, determine the location of the requested data in the cache. The storage manager can then update the metadata based on the cache replacement algorithm. For efficiency, since the metadata can be frequently accessed, the storage manager can maintain the metadata in memory of the client computer.

The structure of the metadata in the memory can depend on the cache replacement algorithm in use. The least recently used (LRU) cache replacement algorithm is well known and widely used for caches. LRU operates on the principle of temporal locality, which suggests that data accessed recently is more likely to be accessed again in the future. LRU ensures that when the cache is full and new data needs to be stored, the least recently used data is evicted to make space. One technique for performing LRU involves managing metadata in the form of a doubly linked list implementing a queue. The items in the queue are stored by data structures of the doubly linked list, where each data structure maps a logical address for data in the remote storage system to a physical address for the data in the cache. Most-recently used (MRU) items can be stored at one end of the queue and LRU items can be stored at the opposite end of the queue. When an item is accessed (e.g., in response to a read/write transaction), the item is moved to the MRU end of the queue. During eviction, an item is removed from the LRU end of the queue. The double links in the list (e.g., each item has a link to a previous item in the queue and the next item in the queue) can aid in moving items in the queue.

A cached remote storage system using LRU cache replacement as discussed above can exhibit inefficiencies in the form of memory consumption and CPU cycle consumption. The size of the metadata for the cache can depend on the size of the cache itself. For example, a client computer can use an SSD having 16 terabytes (TB) capacity as a cache for the remote storage system. The data to be cached can have a granularity of 4 kilobytes (KBs). The physical address space of a 16 TB cache can span 4 billion physical addresses. Metadata for such a cache using LRU can have 4 billion data structures in the doubly linked list (e.g., mappings of logical addresses to the 4 billion physical addresses) and a chained hash table with an array of hash bucket and a singly linked list to resolve hash conflicts. Each data structure in the doubly linked list can include at least bits for the logical address, bits for the physical address, bits for a pointer to the previous data structure in the list, and bits for a pointer to the next data structure in the list. This data structure is at the same time in the singly linked list of the chained hash table. For example, such a data structure can consume up to 60 bytes of memory. Thus, the doubly linked list plus the hash table in this example can consume 240 gigabytes (GBs) of memory in total (e.g., 60 times 4 billion data structures). Memory in the client computer can be a limited resource under contention. Using such a large portion of the memory for the cache metadata can be expensive, inefficient, and have an opportunity cost (e.g., used at the expense of other uses).

Further, the storage manager can frequently access the metadata in the memory while handling read/write transactions on behalf of the software of the client computer accessing the remote storage system. When performing a search operation through the metadata, the CPU can make several reads from the memory while at least processing multiple data structures in the hash table and the doubly linked list. The memory transactions can consume many CPU cycles, which can also be a limited resource under contention in the computer. Using many CPU cycles to process cache metadata can be expensive, inefficient, and have an opportunity cost (e.g., depriving other software of those CPU cycles). Moreover, the doubly linked list needs a global lock before it can be changed. This will serialize many operations on the LRU cache and cannot leverage CPU's multiple cores to process cache requests concurrently. It can be desirable to reduce memory, CPU cycle consumption, and increase concurrency in a computer managing a cache for a remote storage system.

### SUMMARY

In an embodiment, a computer can include a hardware platform including a memory, a central processing unit (CPU) having a first cache for the memory, and a storage device, the storage device configured to store a second cache for a remote storage system accessible by the computer over a network. The computer can include first software executing on the hardware platform and configured to maintain metadata in the memory for the second cache, the metadata including a table having rows, each of the rows controlling multiple entries in the second cache, each of the rows having a first size, the first size less than or equal to a second size of entries in the first cache. The computer can include second software executing on the hardware platform and configured to issue a read or write transaction for an object managed by the remote storage system. The first software can be configured to execute, in response to a first address, a first operation on the CPU to read a first row of the rows from the memory to a first entry of the entries in first cache, execute a second operation on the CPU to search the first row as stored in the first cache for the first address, and perform the transaction based on a result of the second operation to read from or write to the storage device.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a computing system according to some embodiments.

FIG. 2A is a block diagram depicting a computer according to some embodiments.

FIG. 2B is a block diagram depicting a cache for remote storage according to embodiments.

FIG. 3 is a block diagram depicting a logical view of a cached remote storage system according to some embodiments.

FIG. 4 is a logical view of caching remote storage at a computer according to some embodiments.

FIG. 5A is a block diagram depicting organization of metadata according to some embodiments.

FIGS. 5B-5E show tables for example cache and address configurations used for purposes of illustration herein.

FIG. 6 is a block diagram depicting a structure for metadata of a cached remote storage system that uses LRU cache replacement.

FIG. 7A is a block diagram depicting a structure for metadata of a cached remote storage system that uses hot, cold, and ghost queues.

FIG. 7B is a block diagram depicting organization of the cache metadata structure in FIG. 7A for a 2Q cache replacement algorithm.

FIG. 7C is a block diagram depicting organization of the cache metadata structure in FIG. 7A for Clock2Q, Clock2Q+, and S3-FIFO cache replacement algorithms.

FIG. 8A is a block diagram depicting the partitioning of logical address and physical address spaces according to some embodiments.

FIG. 8B is a block diagram depicting a structure for metadata of a cached remote storage system according to some embodiments.

FIGS. 9A-9E are block diagrams depicting cache metadata structures according to some embodiments.

FIG. 10A is a block diagram depicting a structure of a ghost queue according to some embodiments.

FIG. 10B is a block diagram depicting a structure of a ghost queue according to further embodiments.

FIG. 11 is a flow diagram depicting a method of handling a read/write request at a client computer in cached remote storage system according to some embodiments.

FIG. 12 is a flow diagram depicting a method of searching cache metadata for a logical address according to some embodiments.

FIG. 13 is a flow diagram depicting a method of updating cache metadata in response to a cache hit according to some embodiments.

FIG. 14 is a block diagram depicting concurrency data of cache metadata according to some embodiments.

FIG. 15 is a flow diagram depicting a method of processing a cache miss according to some embodiments.

FIG. 16 is a flow diagram depicting a method of updating cache metadata in response to a cache miss according to some embodiments.

FIG. 17 is a flow diagram depicting a method summarizing storage cache lookup according to some embodiments.

FIG. 18A is a flow diagram depicting a method of handling a cache miss when a partition of the cache is not full according to some embodiments.

FIG. 18B is a flow diagram depicting a method of handling a cache miss when a partition of the cache is not full according to other embodiments.

FIGS. 19A-19D are flow diagrams depicting methods of handling a cache miss when a partition of the cache is full according to some embodiments.

FIG. 20 is a block diagram depicting a logical view of caching remote storage at a computer according to some embodiments.

FIG. 21 is a block diagram depicting logical operation of a cache address space manager according to some embodiments.

FIG. 22 is a block diagram depicting a cache metadata structure according to further embodiments.

### DETAILED DESCRIPTION

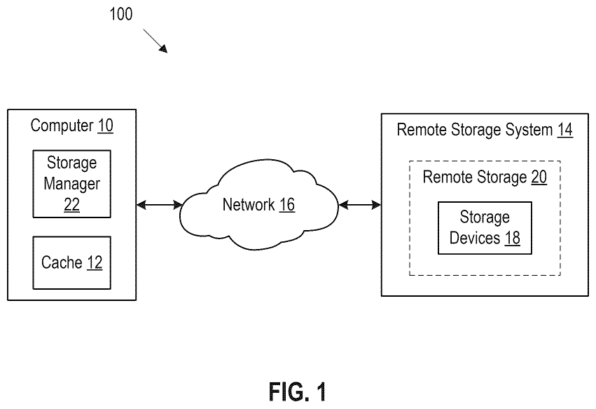

FIG. 1 is a block diagram depicting a computing system 100 according to some embodiments. Computing system 100 can include computers coupled to a network 16. The computers can include a computer 10 and a remote storage system 14. Remote storage system 14 can include storage devices 18. Remote storage system 14 can manage storage devices 18 to provide remote storage 20. Remote storage 20 may be a shared pool of storage for computers on network 16. Storage devices 18 may be magnetic disks (e.g., HDDs), solid-state disks (SSDs), flash storage, persistent memory, and the like as well as combinations thereof. For example, remote storage system 14 can be a storage area network (SAN). A SAN may be a network that provides shared pools of storage to computers (e.g., remote storage 20). In another example, remote storage system 14 can be a cluster of computers having storage devices 18. Software executing in the cluster can manage storage devices 18 as a virtual SAN. A virtual SAN may be a logical representation of a SAN created and managed by software.

In some embodiments, remote storage 20 can store data as objects. An object may be a unit of data. An object can be logically divided into portions, such as fixed-size portions referred to herein as blocks. Software can refer to an object stored by remote storage system 14 using an identifier. Software can refer to a portion of an object using the object's identifier and an address or addresses of block(s) of the object (referred to as “object blocks”). A logical block address (LBA) may be an address for an object block. Thus, software can refer to object block(s) using the object's identifier and LBA(s). An LBA may be an offset of blocks within an object. For example, an object may include some number of blocks between a start (block 0) and an end (block END, where END is an integer greater than zero). An LBA may be OFFSET, where OFFSET is between 0 and END inclusive. Object blocks can match the size of blocks of storage used to store the objects (referred to as “storage blocks”). Thus, one object block can be stored in one storage block. Storage blocks can have a size in terms of bytes referred to herein as BLOCK_SIZE. A byte may be eight bits. In examples described herein, BLOCK_SIZE may be four kilobytes (KBs). A kilobyte may be 1000 bytes or, alternatively, 210 bytes (1024 bytes). Other measurements of bytes that may be used herein include: a megabyte (MB), which may be 1000 KBs; a gigabyte (GB), which may be 1000 MBs; a terabyte (TB), which may be 1000 GBs; and a petabyte (PB), which may be 1000 TBs. The techniques described herein are not limited to BLOCK_SIZE of 4 KBs and other sizes can be used. The terms “object block” and “storage block” are used in this description for ease in explanation and differentiation. It is to be understood that an object block may be referred to variously as block of an object, block, or first, second, third, etc. block in the claims that follow. Similarly, the term “storage block” may be referred to variously as block of storage, block of a storage device, block, or first, second, third, etc. block in the claims that follow.

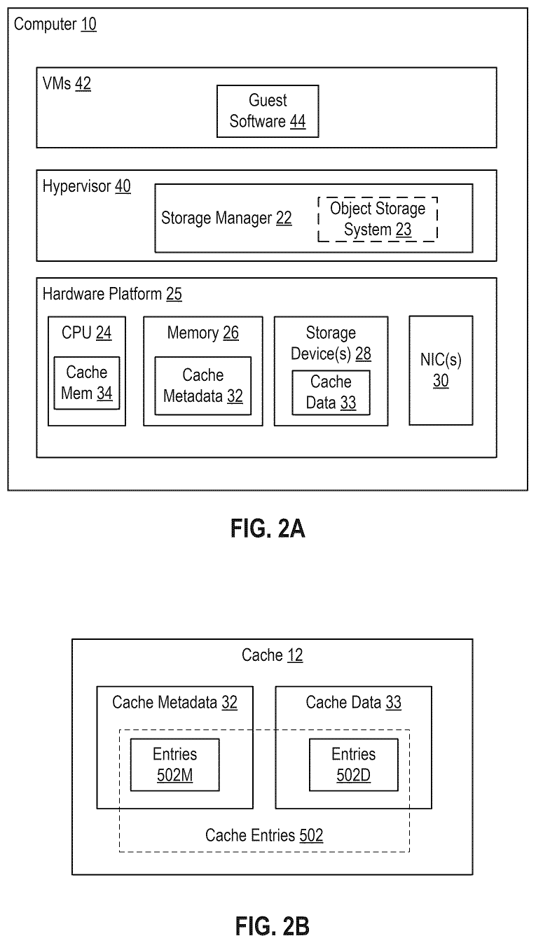

Computer 10 can include a cache 12 and a storage manager 22. Cache 12 may be a cache of object blocks stored by remote storage system 14. Cache 12 may be implemented using storage device(s) of computer 10 (shown in FIG. 2). A storage manager may be logic that manages secondary storage. Storage manager 22 can manage secondary storage for software executing on computer 10, including access to remote storage system 14. Software executing on computer 10 can provide write requests to storage manager 22. A write request may be a request to write data to secondary storage. For example, software on computer 10 can provide a write request to write object block(s) to remote storage 20. Software executing on computer 10 can provide read requests to storage manager 22. A read request may be a request to read data from secondary storage. For example, software on computer 10 can provide a read request to read object block(s) from remote storage 20. Storage manager 22 can be software executing in computer 10. For example, storage manager 22 can implement or be part of a storage subsystem of an operating system (OS) or hypervisor executing on computer 10. Storage manager 22 can manage cache 12, which can include storing copies of object blocks in cache 12 in response to read and write requests, providing object blocks to software from cache 12 in response to read requests, and updating cache 12 in response to read and write requests.

FIG. 2A is a block diagram depicting computer 10 according to some embodiments. Computer 10 can include software executing on a hardware platform 25. Hardware platform 25 can include conventional computer components, such as a central processing unit (CPU) 24, memory 26, storage device(s) 28, and network interface controller(s) (NIC(s)) 30, among other well-known components. A CPU may be a circuit that executes instructions of program(s). Software may be programs executed by a CPU. CPU 24 can be implemented using one or more integrated circuits (ICs). CPU 24 can execute instructions of the software, for example, instructions that perform one or more operations described herein, which may be stored in memory 26. Memory 26 can provide primary storage for computer 10 (e.g., memory 26 can be RAM or the like). Storage device(s) 28 can provide secondary storage for computer 10 (e.g., storage device(s) 28 can be HDDs or SSDs or the like). A NIC may be a device that connects a computer or other device to a network. NIC(s) 30 can connect computer 10 to network 16. Computer 10 can use NIC(s) 30 to communicate with remote storge system 14 over network 16.

Computer 10 includes software that manages hardware platform 25. In some embodiments, this software includes hypervisor 40 managing virtual machines (VMs) 42. Virtualization in a computer may be abstraction, by software, of physical components of the computer into virtual components. The physical components can include CPU, memory, storage, and network components. This abstraction can allow multiple operating systems and applications to execute concurrently on a single computer within isolated VMs. A hypervisor may be software that manages virtualization on a computer, e.g., the creation and operation of VMs. Hypervisor 40 can manage virtualization of hardware platform 25 for VMs 42.

A VM may be software and data that exhibits the behavior of a computer. A VM can include virtual hardware, which may be abstractions of the computer's physical hardware created and managed by the hypervisor. Virtual hardware can include virtual CPU, virtual memory, virtual storage, and virtual network components, each of which may be abstractions created by the hypervisor and supported by corresponding physical components. An operating system (OS) may be software that manages resources and provides common services for other software to access the resources. The resources managed by an OS can be physical hardware of a computer (e.g., the hypervisor can be a type of operating system). A guest operating system (guest OS) may be an operating system executing on the computer concurrently with the hypervisor, but where the managed resources include virtual hardware of a VM. A computer can execute multiple VMs and hence multiple guest operating systems. A guest OS can manage access to the virtual hardware by other software. Guest software may be software executing in the context of a VM, e.g., a guest OS and the other software managed by the guest OS. Each VM 42 can execute guest software 44.

Hypervisor 22 can include storage manager 22. Storage manager 22 can implement or be part of a storage subsystem of hypervisor 40 that manages secondary storage. Storage manager 22 can manage a cache for remote storage 20, e.g., cache 12.

FIG. 2B is a block diagram depicting a cache for remote storage according to embodiments. Cache 12 can include cache metadata 32 and cache data 33. Cache data may be data stored in a cache. Cache data 33 can include object blocks. Cache metadata may be metadata for a cache. Storage manager 22 can use cache metadata 32 to access cache data 33. Storage manager 22 can store cache data 33 in storage device(s) 28. Storage manager 33 can store cache metadata 32 in memory 26. Cache 12 can include entries (referred to as cache entries 502). An entry in a cache may be some unit of data and corresponding metadata for the data unit. Cache entries 502 can include entries 502M and entries 502D, where the suffix “M” connotes “metadata” and the suffix “D” connotes “data.” Cache metadata 32 can include entries 502M and cache data 33 can include entries 502D. The units of data for entries 502D can be blocks of storage device(s) 28. The terms “cache metadata,” “cache data,” and “cache entries” are used in this description for ease in explanation and differentiation. It is to be understood that cache metadata may be referred to variously as metadata of a cache, metadata, or first, second, third, etc. metadata in the claims that follow. Similarly, the term “cache data” may be referred to variously as data of a cache, data, or first, second, third, etc. data in the claims that follow. Likewise, the term “cache entries” may be referred to variously as entries of a cache, entries, or first, second, third, etc. entries in the claims that follow.

In some embodiments, cache metadata 32 can include entries 502M that map logical addresses into physical addresses for blocks of storage device(s) 28. Storage manager 22 can perform a cache lookup using a logical address, obtain a corresponding physical address, and perform a storage transaction on the storage device(s) 28 using the physical address (e.g., a write or read transaction). In another embodiment, storage manager 22 can include an object storage system 23. An object storage system may be software that manages storage of data in objects. Object storage system 23 can be similar to the software of remote storage system 14 that provides remote storage 20. Storage manager 22 can implement cache 12 as an object managed by object storage system 23 (referred to as the cache object). Entries 502M in cache metadata 32 can map logical addresses directly into the cache object. Storage manager 22 can perform a cache lookup using a logical address that directly maps to a logical address of the cache object. Object storage system 23 can handle storing the cache object on storage device(s) 28, where the cache object includes cache data 33 and entries 502D. Storage manager 22 can use the logical address from the cache lookup to access an entry 502D through object storage system 23. Embodiments where storage manager 22 directly manages cache data 33 in storage device(s) 28 are described first below. Thereafter, other embodiments where storage manager 22 can store cache data 33 using a cache object managed by object storage system 23 are described.

Storage manager 22 can handle write and read requests from guest software 44 that target remote storage 20. A request can target remote storage 20 by including a reference to an object block stored by, or to be stored by, remote storage 20. Storage manager 22 can manage cache metadata 32 in response to write and read requests. Another type of cache used in computer 10 is cache memory 34 of CPU 24. Cache memory 34 can cache data from memory 26. A CPU can include a hierarchy of cache memory across different levels referred to as L1, L2, L3, etc. Cache memory in a CPU 24 can be implemented using static random-access memory (SRAM) or the like. In some contexts, cache memory 34 can be referred to as CPU cache and cache 12 can be referred to as remote storage cache. CPU cache may be cache of a CPU (e.g., memory circuits in the CPU). Remote storage cache may be cache for remote storage. The terms “CPU cache” and “remote storage cache” are used in this description for ease in explanation and differentiation. It is to be understood that CPU cache may be referred to variously as cache of CPU, cache memory, cache, or first, second, third, etc. cache in the claims that follow. Similarly, the term “remote storage cache” may be referred to variously as cache of remote storage, cache, or first, second, third, etc. cache in the claims that follow.

In the embodiment shown in FIG. 2A, computer 10 can include hypervisor 40 that manages hardware platform 25. Hypervisor 40 can include storage manager 22. In other embodiments, computer 10 can include an OS that manages hardware platform 25, where the OS can be any commodity OS known in the art. The OS can include storage manager 22. In such embodiments, VMs 42 are omitted and the functions performed by guest software 44 can be performed by software managed by the OS. Various examples are described herein with respect to computer 10 being virtualized and including hypervisor 40 and VMs 42. However, the techniques described herein for managing cache metadata 32 can be performed on a non-virtualized computer executing an OS.

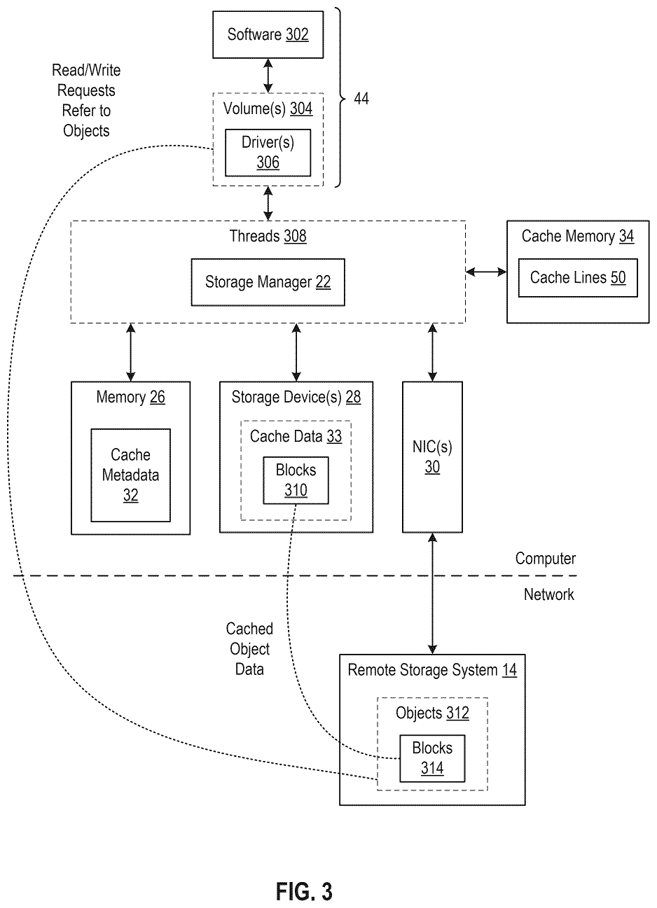

FIG. 3 is a block diagram depicting a logical view of a cached remote storage system according to some embodiments. Software 302 can execute on computer 10 and write and read data from volume(s) 304. A volume may be a logical unit of storage. A volume can be implemented by physical storage. Volume(s) 304 can be implemented by remote storage 20. Software 302 can issue write requests to write object data to volume(s) 304 and read requests to read object data from volume(s) 304. Driver(s) 306 can execute on computer 10. A driver may be software that provides an interface, for use by other software, in accessing a physical device or logical device. Driver(s) 306 can provide an interface to volume(s) 304 for software 302. Driver(s) 306 can communicate with storage manager 22. Software 302 can write object data to volume(s) 304 and driver(s) 306 can send corresponding write requests to storage manager 22. Software 302 can read object data from volume(s) and driver(s) 306 can send corresponding read requests to storage manager 22. Software 302 can write and read objects 312 stored by remote storage system 14 through volume(s) 304 managed by driver(s) 306. In some embodiments, software 302 and drivers 306 can be part of guest software 44 in a virtualized computer. In a non-virtualized computer, software 302 can interact with storage manager 22 using another interface (e.g., an application programming interface (API) of storage manager 22) rather than through driver(s) 306 of a VM.

Storage manager 22 can maintain cache 12 for remote storage 20. Cache data 33 can include data stored in blocks 310 of storage device(s) 28. Blocks 310 can be copies of blocks 314 of remote storage 20. Data in blocks 314 can be blocks of objects 312. Thus, cache data 33 can include cached object data stored in blocks 310 of storage device(s) 28. Storage manager 26 can maintain cache metadata 32 in memory 26. Storage manager 22 can receive write and read requests sourced by software 302. The write and read requests can reference objects 312 (e.g., object identifiers) and portions of objects 312 (e.g., LBAs).

For a read request referencing an object and an LBA, storage manager 22 can process cache metadata 32 to determine if the requested data is resident in cache data 33. As described further herein, storage manager 22 can convert an object identifier and an LBA into a logical address. In some embodiments, \cache metadata 32 can map logical addresses to physical addresses of blocks 310 in storage device(s) 28. A logical address may be an address within a logical address space. A physical address may be an address within a physical address space. An address space may be a set of all addresses that can be represented by some number of bits. A physical address space may be an address space of a hardware component, e.g., storage device(s) 28. A logical address space may be an address space maintained by software as an abstraction of another address space, e.g., an abstraction of a physical address space. Storage manager 22 can determine if the requested data is resident in cache data 33 by searching cache metadata 32 for a mapping between a logical address and a physical address. If the requested data is resident in cache data 33, a condition referred to as a cache hit, storage manager 22 can read the data from cache data 33 (e.g., read a block 310 from storage device(s) 28). A cache hit may be a condition where requested data is in a cache. If the requested data is not resident in cache 12, a condition referred to as a cache miss, storage manager 22 can send the read request to remote storage system 14 using NIC(s) 30. Remote storage system 14 can return the requested data (e.g., a block 314) to storage manager 22. Storage manager 22 can then store the requested data in cache data 33 (e.g., in a block 310 of storage device(s) 28) and return the requested data to software 302. The next time software 302 requests the same data, the data may be resident in cache data 33. When storing data in cache data 33, storage manager 22 can update cache metadata 32 (e.g., update a mapping between a logical address and a physical address).

For a write request referencing an object and an LBA, storage manager 22 can process cache metadata 32 to determine if the referenced data is resident in cache data 33. In some embodiments, storage manager 22 can manage cache 12 as a write-through cache. A write-through cache may be a cache where data is written at or around the same time to both the cache and the storage being cached. If the referenced data is resident in cache data 33, storage manager 12 can update the data (e.g., a block 310 in storage device(s) 28) per the write request and send the write request to remote storage system 14 via NIC(s) 30. If the reference data is not resident in cache data 33, storage manager 12 can store the referenced data in cache data 33 (e.g., in a block 310 in storage device(s) 28) and send the write request to remote storage system 14 via NIC(s) 30. Storage manager 22 can perform similar metadata operations for the write request as described above for the read request.

Cache 12 can have a fixed size (e.g., as determined by the capacity of storage device(s) 28) and eventually can become full (e.g., all blocks 310 can include object data being cached). In this case, to cache additional data, storage manager 22 can evict data from cache 12. Storage manager 22 can implement a cache replacement algorithm that determines which data to evict when caching new data. Various cache replacement algorithms are discussed further herein. Cache metadata 32 can include different fields based on the cache replacement algorithm in use. Naïve implementations of cache metadata 32 can consume significant capacity of memory 26. Various techniques are described herein for reducing the footprint of cache metadata 32 in memory 26 to conserve the memory resource.

Storage manager 22 can execute using multiple threads 308. A thread may be a sequence of software code executing on a CPU. Multiple threads 308 can execute concurrently (e.g., at or around the same time). Cache metadata 32 can include concurrency fields, as discussed further below, to allow threads 308 to read and write cache metadata 32 safely (e.g., without data corruption). To perform metadata operations, threads 308 can read portions of cache metadata 32 from memory 26. CPU 24 can cache such metadata portions in cache memory 34. Cache memory 34 can include a set of cache lines 50. A cache line may be a unit of cache memory. A cache line can store units of data having fixed size determined by the architecture of the CPU. For example, x86 CPUs can have cache lines that store 64-byte data units. Other types of CPUs can have cache lines that store more or less than 64 bytes of data (e.g., 32 bytes of data or 128 bytes of data). Threads 308 can perform operations on cache metadata 32 stored in cache lines 50 (e.g., search and update operations). Naïve implementations of cache metadata 32 can result in many transactions between the CPU and memory to load metadata portions to the cache lines. Various techniques are described herein for structuring cache metadata 32 in memory 26 for efficient use of cache lines 50 to conserve CPU cycles.

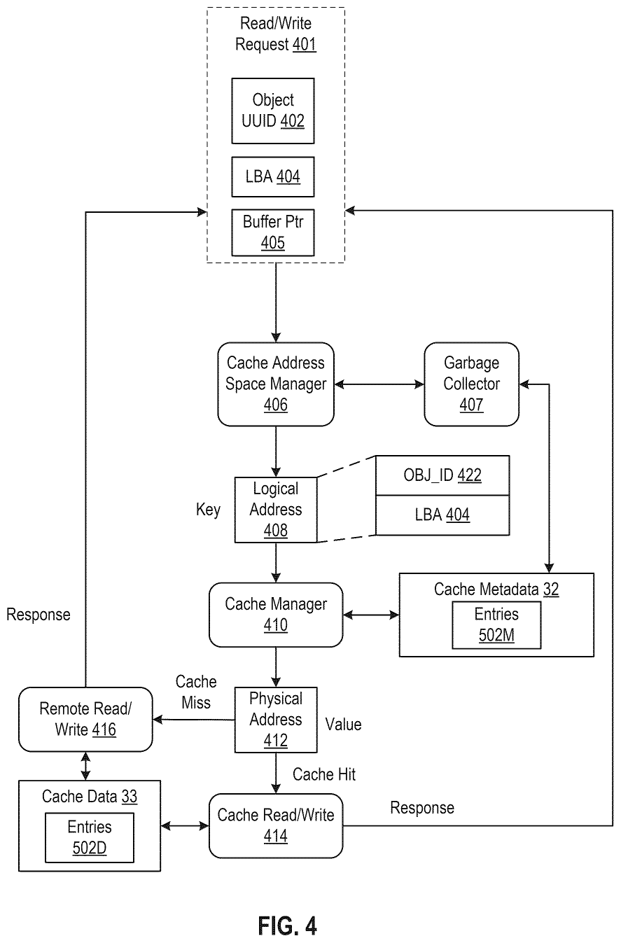

FIG. 4 is a logical view of caching remote storage at a computer according to some embodiments. The logical view in FIG. 4 is for where storage manager 22 stores entries 502D in storage device(s) 28 directly without going through an object storage system. A read/write request may be a request to read data of an object or write data of an object. A read/write request 401 can include an object universally unique identifier (UUID) 402, an LBA 404, and a buffer pointer 405 (shown as “buffer ptr 405”). A UUID can be a label of information (e.g., typically 128 bits). Object UUID 402 can identify an object within the remote storage system. LBA 404 can be an offset of blocks within the object identified by object UUID 402. Buffer pointer 405 can be an address of a buffer in memory 26 that the requesting software has allocated for storing data to be read or having data to be written. Read/write request 401 can include other identifying information, such as an identifier for the remote storage system that manages the object (e.g., a cluster UUID). For purposes of clarity and ease of explanation, the examples described herein assume each object in computing system 100 can be identified using object UUID 402.

Storage manager 22 can receive read/write request 401 from the requesting software. Storage manager 22 can include a cache address space manager 406, cache manager 410, cache read/write handler 414 (shown as “cache read/write 414”), and remote read/write handler 416 (shown as “remote read/write 416”). Cache address space manager 406 can be logic of storage manager 22 that manages translation of object address space for remote storage 20 into a smaller cache address space. Cache address space manager 406 can convert an object UUID 402 and an LBA 404 to a logical address 408. In some embodiments, logical address 408 can include LBA 404, e.g., as the least-significant bits (LSBs). LSBs can be some amount of right-most bits in a set of bits. In contrast, most-significant bits (MSBs) can be some amount of left-most bits in a set of bits. Logical address 408 can include an object identifier (shown as “OBJ_ID 422”) as the MSBs. OBJ_ID 422 can have less bits than object UUID 402 corresponding to a smaller address space. For example, OBJ_ID 422 can be a 14-bit address in an address space of 214 addresses (e.g., 16,384 possible addresses). This would allow for data from up to 16,384 objects to be stored in cache 12. Other bit-widths for OBJ_ID 422 can be used. In some embodiments, cache address space manager 406 can map object UUIDs to OBJ_IDs using an associative array (also referred to as a dictionary or map). An associative array can map keys to values. In this case, object UUIDs can be keys and a corresponding OBJ_IDs can be values. Cache address space manager 406 can maintain data (e.g., a bitmap) to track which OBJ_IDs have been allocated. Cache address space manager 406 can also maintain data that tracks which OBJ_IDs refer to deleted objects. Storage manager 22 can include a garbage collector 407 that can cooperate with cache address space manager 406 to periodically scan cache metadata 32 for deleted OBJ_IDs and remove the corresponding cache entries 502. Logical address 408 can be a key used to lookup a value in cache metadata 32, as described below.

Cache manager 410 can be logic of storage manager 22 that processes cache metadata 32 in response to read/write request 401. Cache manager 410 can receive logical address 408 in response to read/write request 401. Cache manager 410 can search entries 502M of cache metadata 32 using logical address 408 as a key. If cache manager 410 finds logical address 408 in cache metadata 32, this indicates a cache hit. Cache manager 410 can determine, from cache metadata 32, a physical address 412 to which logical address 408 maps (e.g., the value corresponding to the key). Cache manager 410 can supply physical address 412 to cache read/write handler 414 (in case of cache hit) and, in some embodiments, remote read/write handler 416 (in case of cache miss). Physical address 412 can be supplied as a physical block address (PBA) for a block on storage device(s) 28 or information that can be used to determine a PBA (e.g., an offset from a known value that can be used in a formula to determine a PBA).

Cache read/write handler 414 can be logic of storage manager 22. Cache read/write handler 414 can perform a transaction with storage device(s) 28 to perform read/write request 401 (e.g., a read transaction or a write transaction). A read transaction may be a process of reading data from a storage device. A write transaction may be a process of writing data to a storage device. These processes can involve signaling and communication with storage device(s) 28 over an input/output (IO) bus of computer 10. Cache read/write handler 414 can use physical address 412 to read a block of storage device(s) 28 and retrieve data of an entry 502D (for read transaction). Cache read/write handler 414 can use physical address 412 to write data to a block of storage device(s) 28 (for write transaction). Cache read/write handler 414 can respond to read/write request 401 (e.g., notify the requesting software that the request is complete).

In case of cache miss, cache manager 410 can instead invoke remote read/write handler 416. Remote read/write handler 416 can be logic of storage manager 22. Remote read/write handler 416 can perform a transaction with remote storage system 14 to perform read/write request 401. In this case, the transaction can involve signaling and communication over network 14 as well as signaling and communication over the IO bus of computer 10. Remote read/write handler 416 can obtain physical address 412 from cache manager 410 for storing new data in cache 12. Cache manager 410 can implement a cache replacement algorithm to evict data from cache 12 to make room for the new data if necessary. Cache manager 410 can evict data from cache 12 by replacing an entry 502. The new data replaces an entry 502D associated with physical address 412 and new metadata replaces an entry 502M that maps to physical address 412. Remote read/write handler 416 can respond to read/write request 401 (e.g., notify the requesting software that the request is complete).

When processing read/write request 401, cache manager 410 can update cache metadata 32 according to the cache replacement algorithm. This can include updating entries 502M (e.g., updating mappings between logical addresses and physical addresses) and updating overhead data used by the cache replacement algorithm. Updating cache metadata 32 during cache management is discussed further below.

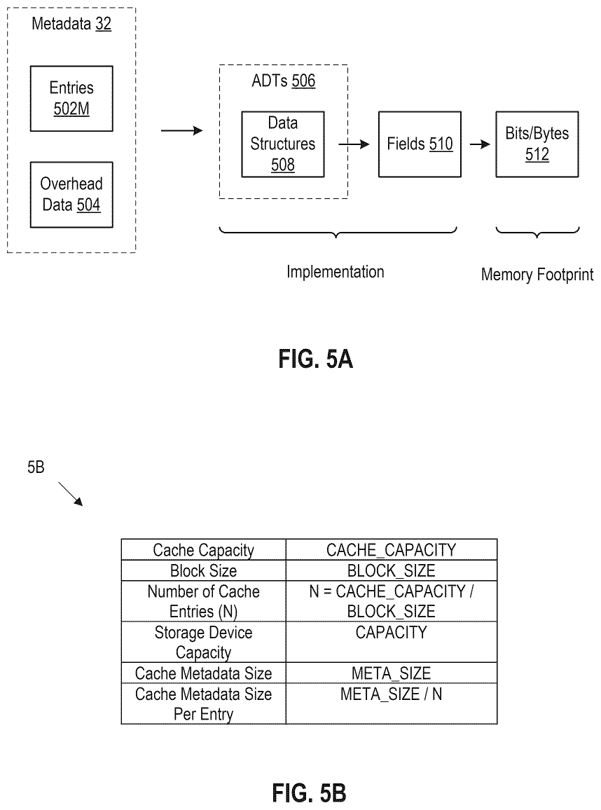

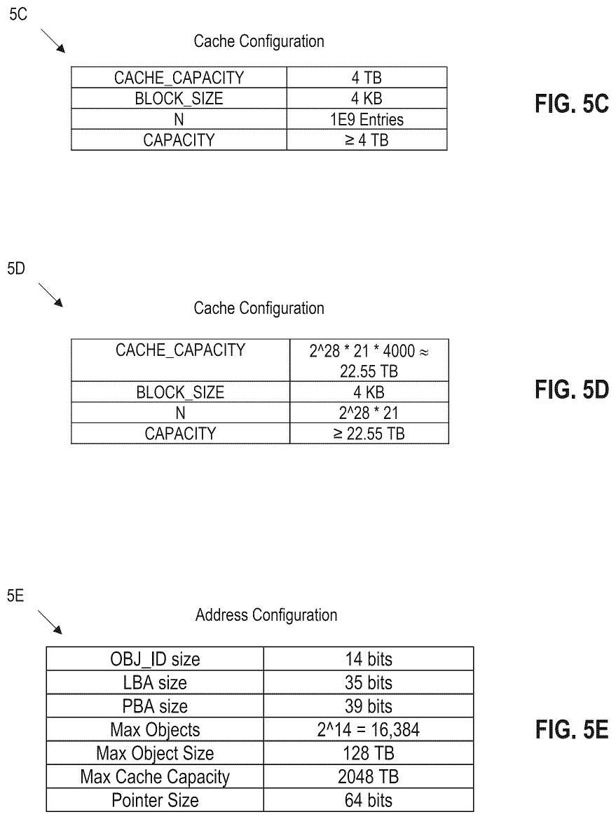

FIG. 5A is a block diagram depicting organization of cache metadata 32 according to some embodiments. Cache metadata 32 can include entries 502M, as discussed above. Each entry 502M can include a logical address and a way to map the logical address to a physical address (example mappings discussed below). In some embodiments, as discussed above, the number of entries 502M corresponds to the number of blocks 310 in storage device(s) 28 implementing cache 12. For example, cache 12 can be implemented using a storage device 28 having capacity of 4 TB. Assuming BLOCK_SIZE of 4 KB, storage device 28 can have one billion blocks, cache 12 can include one billion entries 502, and hence cache metadata 32 can include one billion entries 502M. Cache metadata 32 can include overhead data 504. Overhead data may be data other than a logical/physical address mappings that is used to manage cache 12. For example, overhead data 504 can include data for implementing a cache replacement algorithm and data for managing thread concurrency.

Storage manager 22 can organize cache metadata 32 using abstract data types (ADTs) 506. An abstract data type may be a model for managing data. The model can include possible values for data, possible operations on the data, and the behavior of these operations. Example ADTs include queues, maps, trees, stacks, tables, etc. In some embodiments, ADTs 506 include queues. A queue may be a collection of items that are maintained in a sequence and can be modified by addition and removal of items from the sequence. The queue can have a behavior (e.g., queueing discipline), such as first-in-first-out (FIFO), last-in-first-out (LIFO), serve-in-random-order, and the like. Different uses of queues for cache replacement algorithms are discussed below. Storage manager 22 can implement ADTs 506 using data structures 508. A data structure may be an organization of data into a format for storage. Example data structures include arrays, linked lists, hash tables, and the like, as well as combinations thereof. Data structures 508 can include fields 510. Fields of a data structure can be an area of storage. A field can be characterized by a data type, such as a primitive data type (e.g., integer, floating-point, character, pointer, etc.) or another data structure (e.g., a field of a data structure can be another data structure). Fields 510 can consume bits/bytes 512 (e.g., the area of storage of a field can be measured bits or bytes consumed). ADTs 506, data structures 508 used to implement ADTs 506, and fields 510 of data structures 508 can be an implementation for storing cache metadata 32. Bits/bytes 512 of fields 510 can be the memory footprint of cache metadata 32 having that implementation.

Various techniques are described below for implementation of ADTs 506, data structures 508, and fields 510 that results in an efficient memory footprint of bits/bytes 512 for cache metadata 32. Storage manager 22 can statically allocate cache metadata 32 in memory 26 for efficiency in access during cache management operations. Naïve implementations of cache metadata 32 can have a significant memory footprint, which can be exacerbated by large storage devices used for cache 12. For example, a 16 TB cache with 4 KB block size can result in the static allocation of four billion cache entries 502 along with additional per-entry overhead data 504. A cache entry and overhead per-entry size of even 60 bytes in the example can consume 240 GB of memory for cache metadata 32.

FIGS. 5B-E show tables for examples cache and address configurations used for purposes of illustration herein. The description below refers to these examples when illustrating the memory footprint of cache metadata 32. Specific values in the examples are for purpose of illustration. Those skilled in the art can modify any or all of the values when implementing the techniques described herein.

FIG. 5B shows a table with general values for cache configuration parameters. A capacity of cache 12 (“cache capacity”) can be CACHE_CAPACITY. A block size for cache 12 can be BLOCK_SIZE. A number of cache entries 502 in cache 12 can be N=CACHE_CAPACITY/BLOCK_SIZE. A capacity of storage device(s) 28 can be CAPACITY. The size of cache metadata 32 can be META_SIZE. The size of cache metadata 32 per cache entry 502 can be META_SIZE/N.

FIG. 5C shows an example 5C of a cache configuration used for illustration herein. In example 5C, CACHE_CAPACITY can be 4 TB; BLOCK_SIZE can be 4 KB; N (number of cache entries 502) can be 1 billion (shown in E notation); and CAPACITY can be greater than or equal to 4 TB.

FIG. 5D shows another example 5D of a cache configuration used for illustration herein. In example 5D, CACHE_CAPACITY can be 2²⁸*21*4000 (4 KB), which approximately equals 22.55 TB. The reasons for the factors of 2²⁸ and 21 are discussed below. BLOCK_SIZE can be 4 KB; N can be 2²⁸*21; and CAPACITY can be greater than or equal to CACHE_CAPACITY.

FIG. 5E shows an example 5E of an address configuration used for illustration herein. Example 5E can be combined with either example 5C or 5D or any other cache configuration described herein. In example 5E, the size of OBJ_ID 422 in logical address 408 (“OBJ_ID size”) can be 14-bits. The size of LBA 404 in logical address 408 can be 35 bits. The size of a PBA (e.g., physical address) can be 39 bits. With these values, the maximum number of objects supported by cache 12 can be 16,384 objects. The maximum object size can be approximately 128 TB. The maximum cache capacity can be 2048 T B. Cache metadata 32 can store pointers. A pointer may be an integer value, which can be interpreted by software as an address, e.g., an address in memory 26. Modern CPUs can use 64-bit addresses. In example 5E, the pointer size can be 64 bits (8 bytes).

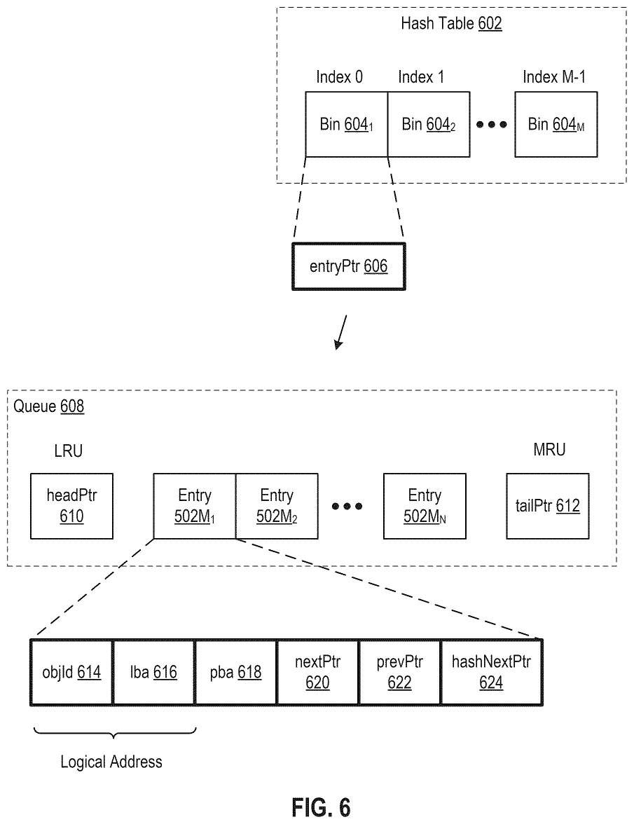

FIG. 6 is a block diagram depicting a structure for metadata of a cached remote storage system that uses LRU cache replacement. The structure in FIG. 6 can be described with respect to cache metadata 32. Various improved structures for cache metadata 32 with respect to the structure in FIG. 6 are described below. Cache metadata 32 can include a hash table 602 and a queue 608. Queue 608 can be implemented using a doubly linked list data structure. A doubly linked list may be a sequence of items where each item includes a pointer to a previous item in the sequence and another pointer to the next item in the sequence. Queue 608 can include a head pointer (stored in a field headPtr 610), entries 502M₁ . . . 502M_{N} (where N is an integer greater than one and equals the number of cache entries 502 in cache 12), and a tail pointer (stored in a field tailPtr 612). Each entry 502Mₖ (k∈{1, 2, . . . , N}) can include a data structure with fields including: objId 614, lba 616, pba 618, nextPtr 620, prevPtr 622, and hashNextPtr 624. Hash table 602 can include bins 604₁ . . . 604_{M} (where M is an integer greater than one). Each bin 604ⱼ (j∈{1, 2, . . . , M}) can include an entry pointer (stored in a field entryPtr 606).

Operation can be understood in conjunction with FIG. 4. In operation, logical address 408 can be hashed (e.g., input to a hash function) and the result mapped to a bin 604ⱼ. Each bin 604₁ . . . 604_{M} can have an index (e.g., zero based indexes in the example). A hash function may be a mathematical function or algorithm that takes a variable number of input bits and generates an output having a fixed number of output bits. The output of the hash function can be a value between 0 and M−1 (or a value between 0 and M−1 can be derived from such output using a modulo-M operation). The output can be used to select a bin 604ⱼ. Each bin 604₁ . . . 604_{M} can include an entry pointer 606. Entry pointer 606 in a selected bin 604ⱼ can point to an entry 502Mₖ. Hash table 602 can have a load factor of 75%. The load factor of a hash table may be the number of items in the hash table (referred to as the load of the hash table) divided by the number of bins. Using example 5B, there can be N cache entries and hence the load of hash table 602 can be N (e.g., hash table 602 can map N logical addresses). For a load factor of 75%, the number M of bins can be 4/3*N. This means that hash table 602 can include an allocation in memory of four entry pointers for every three cache entries.

Entries 502M₁ . . . 502M_{N} in queue 608 correspond to cache entries of the cache. Each entry 502Mₖ can include a logical address field comprising objId 614 and lba 616. For logical address 408, objId 614 can store OBJ_ID 422 and lba 616 can store LBA 404. Logical address 408 can be hashed into bin 604ⱼ. If entryPtr 606 stores nil (where nil denotes meaningless or empty value), then logical address 408 is not mapped by cache metadata 32 and a cache miss occurs. If entryPtr 606 stores a valid pointer to an entry 502M, this pointer is the head of list of entries in which logical address 408 may be stored. Hash table 602 can support collisions. A collision in a hash table may be an event where multiple different inputs are hashed into the same bin. The field entryPtr 606 can be the head of a singly linked list of entries 502M, where the links between entries in the singly linked list are stored in hashNextPtr 624. A value of nil in hashNextPtr 624 can indicate the tail of the singly linked list. If logical address 408 is not in the list pointed to by bin 604ⱼ, then a cache miss occurs. If the logical address 408 is present in the list, then a cache hit occurs. On cache hit, pba 618 in the entry matching logical address 408 stores physical address 412.

If queue 608 is full, and a cache miss occurs, then the entry stored in the LRU end of queue 608 (e.g., the entry at the head) can be evicted. A new entry can be inserted into queue 608 at the MRU end (e.g., the tail). Eviction and insertion can be performed by modifying values in headPtr 610 and tailPtr 612, nextPtr 620 in the new head, prevPtr 622 in the old tail, and the fields of the new tail.

The cache metadata for an LRU scheme can consume significant memory. Consider example 5E, where objId 614, lba 616, and pba 618 store 11 bytes and pointer fields store 8 bytes. Next pointer 620 and previous pointer 622 can consume 16 bytes per cache entry. Hash table 602 with 75% load factor requires 2.33 pointers per cache entry (e.g., one hashNextPtr 624 per cache entry, and four entryPtr 606 for every three cache entries), consuming 2.33*8 bytes. Thus, the total space consumed per cache entry is 11+2.33*8+2*8=45.64 bytes. Consider example 5C, a 4 TB cache can require 45.64 GB in memory for its cache metadata using the LRU scheme of FIG. 6.

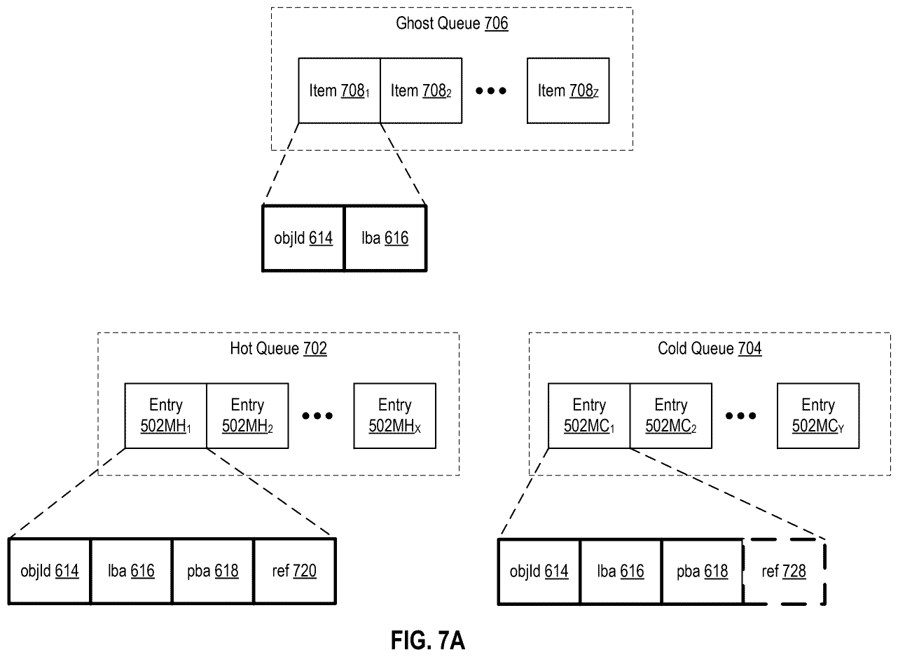

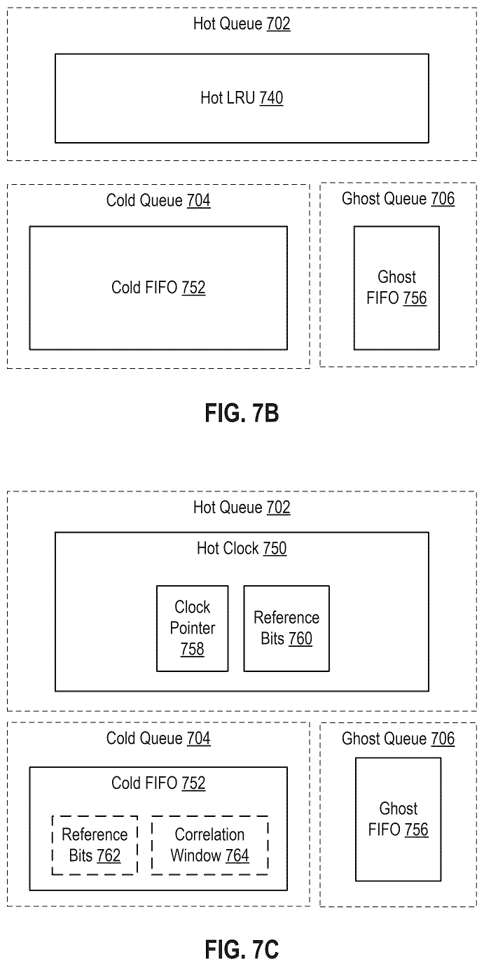

FIG. 7A is a block diagram depicting a structure for cache metadata of a cached remote storage system that uses hot, cold, and ghost queues. This type of metadata structure can be used with several cache replacement algorithms, such as 2Q, Clock2Q, S3-FIFO, Clock2Q+ and derivations thereof. For simplicity, the head and tail pointers for the queues are not shown. A hot queue 702 can include entries 502MH₁ . . . 502MH_{X}. A cold queue 704 can include entries 502MC₁ . . . 502MC_{Y}. A ghost queue 706 can include items 708₁ . . . 708_{Z}. The integers X, Y, and Z can depend on the type of cache replacement algorithm. For example, in 2Q and Clock2Q, the hot queue can be ¾ times the number of cache entries, the cold queue can be ¼ times the number of cache entries, and the ghost queue can be ½ times the number of cache entries. In S3-FIFO and Clock2Q+, the hot queue can be 9/10 times the number of cache entries, the cold queue can be 1/10 times the number of cache entries, and the ghost queue can be between N and some fraction of N (e.g., 0.5*N), where N is the number of cache entries. A brief description for each of these algorithms is set forth below. Regardless of cache replacement algorithm, X+Y=N (the number of cache entries in cache metadata 32) and Z≤N (e.g., 0.5*N will be used for purposes of illustration in some examples).

FIG. 7B is a block diagram depicting organization of the cache metadata structure in FIG. 7A for a 2Q cache replacement algorithm. In 2Q, the cache metadata can be separated into three parts: a hot LRU 740 (an implementation of hot queue 702), a cold FIFO 752 (an implementation of cold queue 704), and a ghost FIFO 756 (an implementation of ghost queue 706). A FIFO may be a queue where the first item enqueued is the first item to be dequeued. Items can be enqueued (also referred to as inserted) at the tail of a FIFO and items can be dequeued (also referred to as removed or evicted) from the head of the FIFO. Ghost FIFO 756 can store only logical addresses rather than full cache entries. On a cache hit, if the logical address is found in hot LRU 740, the entry is managed using LRU as described above in FIG. 6. If the logical address is instead found in cold FIFO 752, no metadata update is needed. On cache miss, if the logical address is not found in ghost FIFO, a new entry is inserted in cold FIFO 752. If there is no room in cold FIFO 752, its head entry (the oldest entry) is evicted, but the logical address of the evicted entry is inserted into ghost FIFO 756. If ghost FIFO 756 is full, its head entry (the oldest entry) is evicted. On cache miss, if the logical address is found in ghost FIFO 756, it is taken to mean that the new entry should be a hot entry mistakenly evicted from cold FIFO 752. The new entry is then added to hot LRU 740. If hot LRU 740 is full, its LRU entry is evicted.

FIG. 7C is a block diagram depicting organization of the cache metadata structure in FIG. 7A for Clock2Q, Clock2Q+, and S3-FIFO cache replacement algorithms. Clock2Q can be similar to 2Q but replacing hot LRU 740 with a hot clock 750. This lowers CPU and memory overhead for the cache replacement algorithm and also allows concurrent access of the cache from multiple CPU cores. A clock in this context may be a circular queue and a pointer that moves from one entry to the next in the queue (e.g., like the hand of a clock). When an entry is accessed, a reference bit is set for that entry. When an eviction is needed, the entry pointed to by the clock pointer is evaluated for eviction. If its reference bit was set, the reference bit is now unset and the clock pointer advances to the next entry. If the clock pointer lands on an entry with an unset reference bit, that entry is evicted. A hot clock may be a clock implementation of a hot queue. Hot clock 750 can include clock pointer 758 and reference bits 760 for the entries therein. Otherwise, Clock2Q can function as above for the 2Q algorithm. The entries in cold FIFO 704 do not include reference bits or such reference bits are ignored.

S3-FIFO can be similar to Clock2Q, but now the entries in cold FIFO 752 can include reference bits 762 to record whether the entries have been referenced in a while. If an entry is accessed in cold FIFO 752, its reference bit 762 is set. Later, if an entry is evicted from cold FIFO 752 with its reference bit set, this entry is moved to hot clock 750. If an entry is evicted from cold FIFO 752 with its reference bit unset, this entry's logical address is inserted in ghost FIFO 756.

Clock2Q+ can be based on Clock2Q and S3-FIFO. The main change is that cold FIFO 752 can have a correlation window that can be 20% of the cold queue size or 2% of the total number of cache entries, for example. Thus, cold FIFO 752 can include a correlation window 764. When an entry in cold FIFO 752 is accessed, if the entry is within correlation window 764, its reference bit will not be set. Correlation window 764 can be some number of entries from the head of cold FIFO 752 (e.g., the insertion end of cold FIFO 752). This means that if correlated references happen within a short period, the entry will not be treated as hot. After the entry moves out of correlation window 764, if the entry is accessed again, its reference bit can be set to make sure the entry will move directly to hot clock 750 if it is evicted.

Returning to FIG. 7A, in some embodiments, each entry 502MH₁ . . . 502MH_{X} in hot queue 702 can include fields objId 614, lba 616, pba 618, and a field ref 720. The field ref 720 can store a reference bit. Similar to hot queue 702, entries 502MC₁ . . . 502MC_{X} in cold queue 704 can include fields for objId 614, lba 616, pba 618, and optionally a field for ref 728. The field ref 728 can store a reference bit. The items in ghost queue 706 are not fields 502M of cache metadata 32, but rather the items track logical addresses evicted from cold queue 704. That is, ghost queue 706 can be part of overhead data 504. Thus, in some embodiments, each item 708₁ . . . 708_{Z}, can include fields for objId 614 and lba 616 (e.g., the logical address). Embodiments for data structures and fields thereof to implement hot queue 702, cold queue 704, and ghost queue 706 are described below. More efficient data structures for implementing ghost queue 706 are also described below.

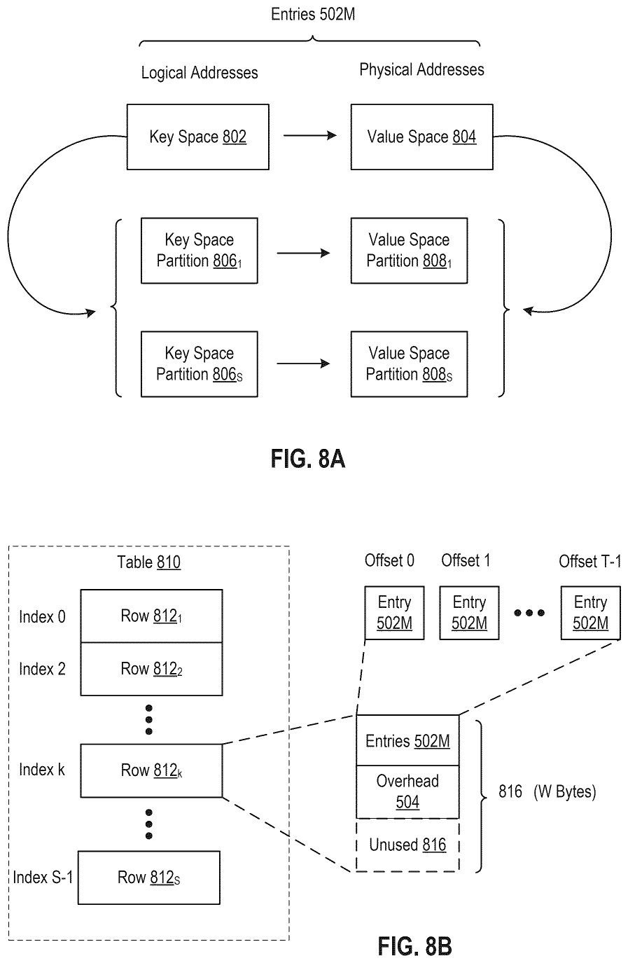

FIG. 8A is a block diagram depicting the partitioning of logical address and physical address spaces according to some embodiments. A key space 802 can include all possible logical addresses used as keys to search cache metadata 32 in response to a read/write request. A value space 804 can include all possible physical block addresses used as values mapped to the keys in key space 802. That is, cache metadata 32 can include a set of entries 502M that map logical addresses to physical addresses, or stated differently, keys in key space 802 to values in value space 804. Key space 802 can be partitioned into key space partitions 806₁ . . . 806_{S} (where S is an integer greater than one). Likewise, value space 804 can be partitioned into value space partitions 808₁ . . . 808_{S}. The keys in key space partition 806ₖ (k between 1 and S inclusive) can be mapped to values in value space partition 808ₖ.

FIG. 8B is a block diagram depicting a structure for cache metadata 32 of a cached remote storage system according to some embodiments. Cache metadata 32 can include a table 810 having rows 812₁ . . . 812_{S}. A table may be a data structure having rows accessible using indexes. Row 812ₖ can include entries 502M that map logical addresses in key space partition 806ₖ to physical block addresses in value space partition 808ₖ. Each row 812ₖ can include entries 502M, overhead 504, and optionally unused space 816. Each row 812ₖ can be of fixed size 816 (e.g., W bytes where W is an integer greater than one). In some embodiments, as discussed further below, the size of each row 812ₖ can be less than or equal to the data size of a cache line 50 in the CPU cache. For example, the size of each row 812ₖ can be 64 bytes to match the amount of data that fits in a cache line of an x86 CPU. Unused space 816 may be present in embodiments where entries 502M and overhead 504 do not consume the entire fixed size of row 812ₖ. Rows 812 can include indexes, e.g., index 0 . . . index S−1. Entries 502M in a row 812ₖ can include offsets, e.g., offset 0 . . . offset T−1, where T is the number of entries 502M stored in the row.

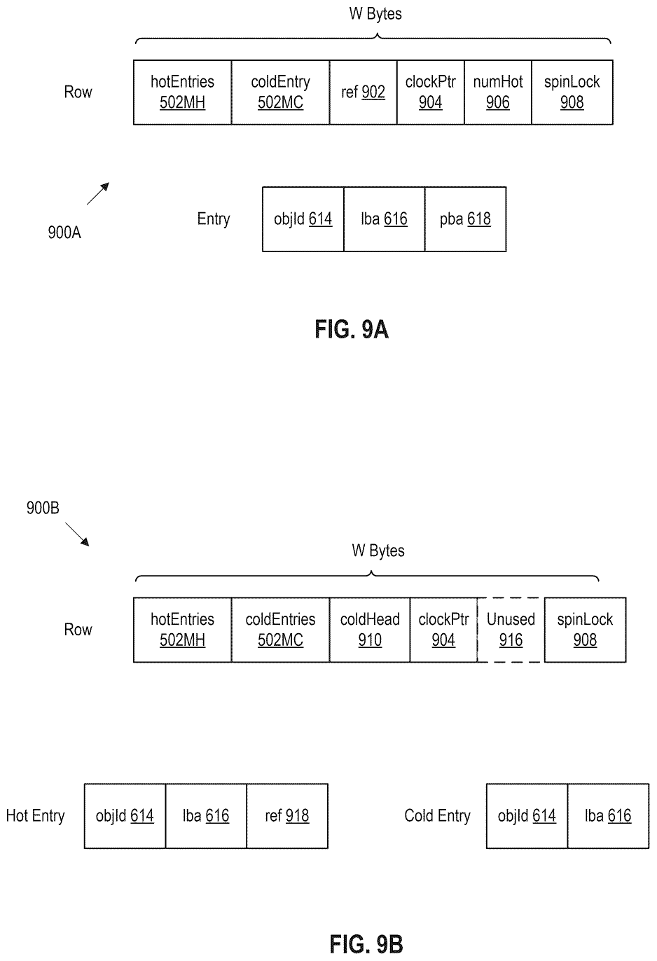

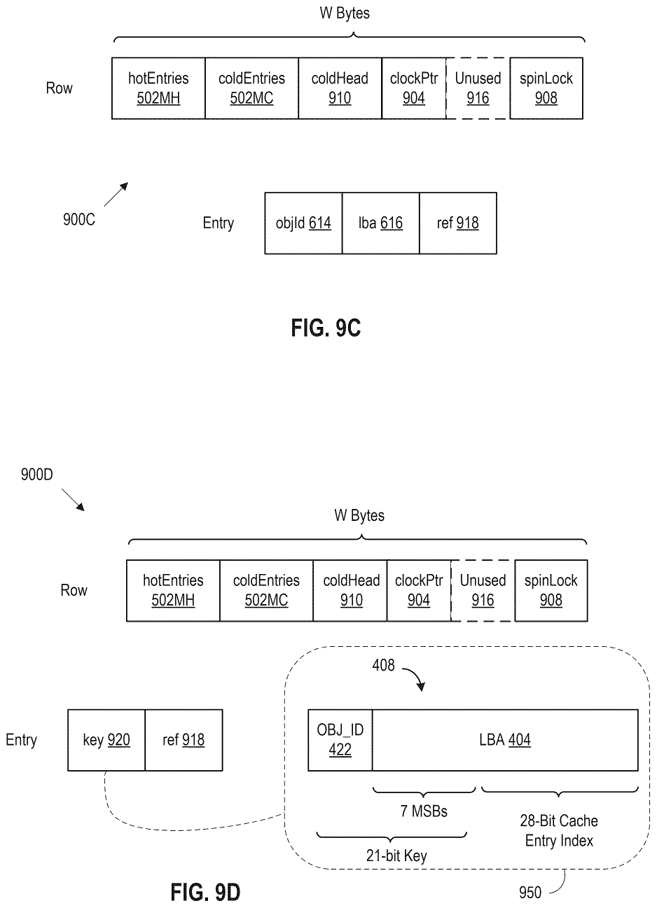

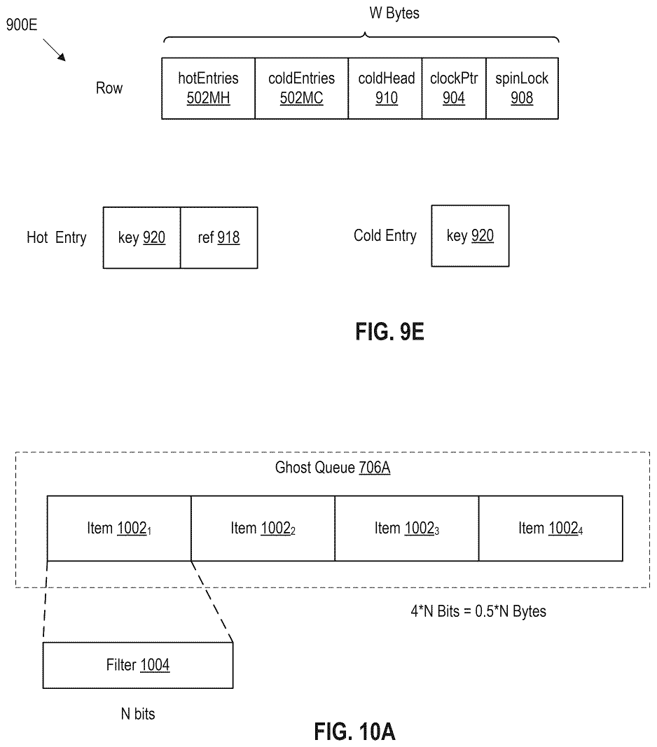

FIG. 9A is a block diagram depicting a cache metadata structure 900A according to some embodiments. The structure of ghost queue 706 is omitted and discussed separately below. A row 812 of W bytes can include fields for hotEntries 502MH, a coldEntry 502MC, a ref 902, clockPtr 904, numHot 906, and spinlock 908. An entry 502M can include fields for objId 614, lba 616, and pba 618. In C/C++ programming language notation, an entry 502M can be specified as:

struct Entry {

// Structure for Example 5E
// unit64 can be a 64-bit, unsigned integer primitive type
// the notation :xx indicates only xx bits of the type
unit64 objId: 14;
unit64 lba:35;
unit64 pba:39;

};

In row 812, there can be some number of hot entries 502MH of a hot clock (e.g., four hot entries). There can be some number of cold entries 502MC for a cold FIFO, e.g., a single cold entry 502MC. The field ref 902 can be an array of reference bits for hot entries 502MH, e.g., one for each of the four hot entries 502MH. The field clockPtr 904 can store a clock hand for the hot clock, e.g., two bits in order to rotate around four hot entries 502MH. The field numHot 906 can represent a number of valid hot entries 502MH, e.g., two bits. The field spinLock 908 can include concurrency bits to manage thread concurrency. In an example, spinLock 908 includes 8 bytes. In C/C++ programming language notation, a row 812 can be specified as:

struct TableRow {

struct Entry hotEntries[4];
struct Entry coldEntry;
unit8 ref:4;
unit8 clockPtr:2;
unit8 numHot:2;
unit64 spinLock;

};

In the example data structures Entry and TableRow, the total size of TableRow is 64 bytes (e.g., W=64 bytes). Since there are five entries 502M per row 812, table 810 can consume 12.8 bytes per cache entry. Cache metadata 32 can include additional overhead data 504 not present in table 810, which includes ghost queue 706. Additional embodiments of a ghost queue are described below. However, in some embodiments, the ghost queue can include items for 50% of the cache entries and, using probabilistic data structures, can consume 0.5 byte (four bits) per cache entry. Thus, in such an embodiment, cache metadata 32 can consume 13.3 bytes per cache entry. In examples 5C and 5E, cache metadata 32 can consume 13.3 GB of memory, significantly less than the LRU scheme for the same cache and address configurations.

In operation, referring to FIG. 4 in combination with FIGS. 8B and 9A, cache manager 410 can receive logical address 408 (e.g., <OBJ_ID, LBA>). Cache manager 410 can implement a cache replacement algorithm, such as Clock2Q, using cache metadata 32 having structure as shown in FIGS. 8B and 9A. Cache manager 410 can use a hash function to map logical address 408 to an index of table 810 to select a row 812. That is, each row 812 can be given an index (e.g., indices 0 to S−1) and the hash function can output a value modulo S to select a row. In the example, each row can accommodate five entries before cache manager 410 performs evictions for that row. After determining a row 812 in table 810, cache manager 410 can perform an operation on CPU 24 to load the row from memory 26, where CPU 24 can load the row into a cache line 50 in response to the operation. Cache manager 410 can then perform a linear search of the row as stored in the cache line for logical address 408. If found, a cache hit occurs. Otherwise, a cache miss occurs. Cache hit/miss is described above. Cache manager 410 can update the row in the cache line using semantics of the cache replacement algorithm (e.g., Clock2Q semantics). CPU clock cycles can be conserved by obviating the need to load additional rows or entries into from the memory into additional cache lines to perform the search and update operations for a given read/write request in which an entry of the cache is referenced.

FIG. 9B is a block diagram depicting a cache metadata structure 900B according to further embodiments. The structure of the ghost queue is omitted and discussed separately below. Elements of FIG. 9B that are the same or similar to those of FIG. 9A are designated with identical reference numerals. With structure 900B, each row 812 can be optimized in that the entries do not need to store an explicit PBA. Due to the fixed structure of table 810, with rows 812 having a fixed size of W bytes, the PBA mapped to a given LBA can be inferred from the location of the entry, e.g., the offset of the entry in its row. That is, each entry stored by table 810 can be associated with a specific PBA, which can be calculated based on the row index and the entry offset. In such case, pba 618 can be dropped from the cache entries. Further, structure 900B can include different entry types for the hot clock and the cold FIFO. Each hot entry 502MH can include fields objId 614, lba 616, and ref 918. The respective bit of ref 902 can be incorporated into each hot entry 502MH as ref 918. Thus, ref 902 can be removed as a separate field in row 812. Structure 900B can be suitable for Clock2Q and the like, for example, and as such each cold entry 502MC can include fields objId 614 and lba 616 without a reference bit (since such algorithms do not use reference bits for cold FIFO entries). In structure 900B, row 812 can include a field coldHead 910 that specifies the head of the cold FIFO. In C/C++ programming language notation, structure 900B can be specified as:

struct HotEntry {

// Structure for Example 5E
unit64 objId:14;
unit64 lba:35;
unit64 ref:1;

};
struct ColdEntry {

// Structure for Example 5E
unit64 objId:14;
unit64 lba:35;

};
struct TableRow {

struct HotEntry hotEntries[7]; // Total of 7 hot entries 502MH
struct ColdEntry coldEntries[2]; // Total of 2 cold entries 502MC
unit64 clockPtr:3;
unit64 coldHead:1;
unit64 unused:28;
unit32 spinLock;

};

This example is similar to that above for FIG. 9A, except that there are 7 hot entries and 2 cold entries. In such case, the clock pointer uses 3 bits (to traverse the 7 hot entries). One bit is needed to track the head of the cold queue (which has two entries). The spin lock field can be reduced to 32 bits from 64 bits.

In the example data structures Entry and TableRow, the total size of TableRow is 64 bytes (e.g., W=64 bytes). Since there are nine entries 502M per row 812, table 810 can consume 64/9 bytes per entry. Cache metadata 32 can include additional overhead data 504 not present in table 810, which includes the ghost FIFO. Embodiments of the ghost FIFO are described below. However, in some embodiments, the ghost FIFO can include items for 50% of the cache entries and, using probabilistic data structures, can consume 0.5 byte (four bits) per cache entry. Thus, in such an embodiment, cache metadata 32 can consume 7.51 bytes per cache entry. For Examples 5C and 5E, cache metadata 32 can consume 7.51 GB of memory, significantly less than the LRU scheme for the same cache and address configurations. Cache manager 410 can operate as described above with respect to FIG. 9A, with the exception of inferring the PBA from the offset of the entry having the logical address.

FIG. 9C is a block diagram depicting a cache metadata structure 900C according to further embodiments. The structure of the ghost queue is omitted and discussed separately below. Elements of FIG. 9C that are the same or similar to those of FIG. 9B are designated with identical reference numerals. Structure 900C is similar to structure 900B with the exception that a common entry type is used rather than separate entry types for hot clock and cold FIFO. This incurs use of two extra bits for ref 918 in cold entries 502MC. The two extra bits can be taken from unused 916 (which can now be 26 bits instead of 28 bits in the example). Cache metadata 32 with structure 900C (with 0.5 bytes per entry by ghost FIFO) can consume 7.51 bytes per cache entry.

FIG. 9D is a block diagram depicting a cache metadata structure 900D according to further embodiments. The structure of the ghost queue is omitted and discussed separately below. Elements of FIG. 9D that are the same or similar to FIG. 9C are designated with identical reference numerals. The structure of row 812 in structure 900D is the same as in 900C. However, the entry structure can be changed to include fields for key 920 and ref 918. Consider cache configuration of Example 5D and address configuration of Example 5E. Table 810 can include 2²⁸ rows 812 (e.g., S=2²⁸). Rows 812 can be identified by index (e.g., a zero-based index between 0 and S−1). This index can be referred to as a cache entry index. As shown in view 950, the 28 LSBs of logical address 408, which are the 28 LSBs of LBA 404, can be used as a cache entry index to select a row in table 810. The 7 MSBs of LBA 404 can be combined with the 14 bits of OBJ_ID 422 to make a 21-bit key (where OBJ_ID 422 are the MSBs of the key and the 7 MSBs of LBA 404 are the LSBs of the key). The field key 920 in each entry can include storage for such a 21-bit key. In C/C++ programming language notation, structure 900D can be specified as:

struct Entry {

// Structure for Examples 5D and 5E
unit64 key:21;
unit64 ref:1;

};
Struct TableRow {

struct Entry hotEntries[17]; // Total of 17 hot entries 502MH
struct Entry coldEntries[4]; // Total of 4 cold entries 502MC
unit64 coldHead:2;
unit64 clockPtr:5;
unit64 unused:11;
unit32 spinLock;

};

In the example data structures Entry and TableRow, the total size of TableRow is 64 bytes (e.g., W=64 bytes). Since there are 21 entries 502M per row 812, table 810 can consume 64/21 bytes per entry. Cache metadata 32 can include additional overhead data 504 not present in table 810, which includes the ghost FIFO. Some embodiments of the ghost FIFO are described below. However, in some embodiments, the ghost FIFO can include items for 50% of the cache entries and, using probabilistic data structures, can consume 0.5 byte (four bits) per cache entry. Thus, in such an embodiment, cache metadata 32 can consume 3.55 bytes per cache entry. For Examples 5D and 5E, cache metadata 32 can consume 3.55 GB of memory, significantly less than the LRU scheme for the same cache and address configurations. Cache manager 410 can operate as described above with respect to FIG. 9A, with the exception of inferring the PBA from the offset of the logical address.

In the example above, table 810 can include 2²⁸ rows 812, each row having 21 cache entries. Thus, table 810 can have 2²⁸*21 offsets representing physical addresses of 4 KB blocks (e.g., approximately 22.5 TB of space for cache data). If storage device(s) 28 have less capacity, the structure shown in FIG. 9D can be used, but with a different number of rows 812 in table 810, a different number of bits for cache entry index, a different number of bits for key 920, and a different number of cache entries per row.

FIG. 9E is a block diagram depicting a cache metadata structure 900E according to further embodiments. The structure of the ghost queue is omitted and discussed separately below. Elements of FIG. 9E that are the same or similar to FIG. 9D are designated with identical reference numerals. Structure 900E is similar to structure 900D, except that there can be separate structures for hot and cold entries. This can save a reference bit per cold entry (e.g., 4 bits). Further savings can be obtained by reducing spinlock 908 from 4 bytes to a smaller number. In C/C++ programming language notation, structure 900DE can be specified as:

struct HotEntry {

// Structure for Examples 5D and 5E
unit64 key:21;
unit64 ref:1;

};
struct ColdEntry {

// Structure for Examples 5D and 5E
unit64 key:21;

};
Struct TableRow {

struct HotEntry hotEntries[19]; // Total of 19 hot entries 502MH
struct Entry coldEntries[4]; // Total of 4 cold entries 502MC
unit64 coldHead:2;
unit64 clockPtr:5;
unit64 spinLock:3;

};

In the example data structures Entry and TableRow, the total size of TableRow is 64 bytes (e.g., W=64 bytes). Since there are 23 entries 502M per row 812, table 810 can consume 64/23 bytes per entry. Cache metadata 32 can include additional overhead data 504 not present in table 810, which includes the ghost FIFO. Some embodiments of the ghost FIFO are described below. However, in some embodiments, the ghost FIFO can include items for 50% of the cache entries and, using probabilistic data structures, can consume 0.5 byte (four bits) per cache entry. Thus, in such an embodiment, cache metadata 32 can consume 3.28 bytes per cache entry. For Examples 5D and 5E, cache metadata 32 can consume 3.28 GB of memory, significantly less than the LRU scheme for the same cache and address configurations. Cache manager 410 can operate as described above with respect to FIG. 9A, with the exception of inferring the PBA from the offset of the logical address.

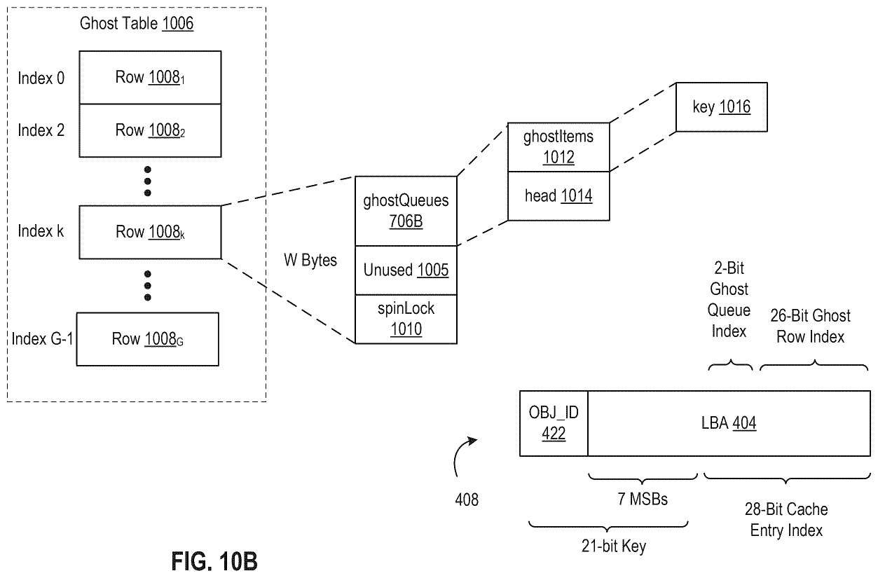

FIG. 10A is a block diagram depicting a structure of a ghost queue 706A according to some embodiments. Ghost queue 706A can consume less memory than ghost queue 706 shown in FIG. 7 by using probabilistic data structures. A probabilistic data structure may be a data structure that can provide approximate answers to queries of a large data set. One example probabilistic data structure is a Bloom filter, where false positive matches are possible but false negative matches are not possible. That is, a query against a Bloom filter returns either probably in the set or definitely not in the set. Ghost queue 706A can include a sequence of four items 10021 . . . 10024. Each item 1002 can store a filter 1004 of N bits (where N is the number of cache entries). Filter 1004 can be a Bloom filter. Thus, ghost queue 706A can consume 4*N bits or 0.5*N bytes (e.g., 0.5 bytes per cache entry). Bloom filters are well known in the art. A brief explanation is provided below for clarity.

An empty Bloom filter can be a bit array of N bits, all set to 0. Cache manager 410 can use h different hash functions, each of which map logical addresses to one of the N possible bit array positions. To be optimal, the hash functions can be uniformly distributed and independent. To add a logical address, cache manager 410 can input the logical address to each of the h hash functions to get h array positions. Cache manager 410 can set the bits at all these positions to 1. To test whether a logical address is in the cache, cache manager 410 can input the logical address to each of the h hash functions to get h array positions. If any of the bits at these positions is 0, the logical address is definitely not in the cache; if the logical address were in the cache, then all the bits would have been set to 1 when it was inserted. If all the bits are 1, then either the logical address is in the cache, or the bits have by chance been set to 1 during the insertion of other logical addresses, resulting in a false positive.

Ghost queue 706A can include multiple filters (e.g., four filters). Cache manager 410 can add logical addresses to the filter at the head of ghost queue 706A until a threshold load is reached (e.g., N/8 logical addresses). Then, cache manager 410 can rotate the queue to use a new filter at the head. When all filters are full, cache manager 410 can clear the least-recently-used filter for reuse. Other types of probabilistic data structures can be used in place of Bloom filters, such as quotient filters or the like.

FIG. 10B is a block diagram depicting a structure of a ghost queue according to some embodiments. The ghost queue can be implemented using a ghost table 1006 having rows 10081 . . . 1008G. Each row can be identified by an index (e.g., zero-based index 0 to G−1). Similar to table 810, each row can have a fixed size of W bytes (e.g., the size of data in a CPU cache line). Each row 10081 . . . 1008G can include a set of ghost queues (ghostQueues 706B), unused bits 1005 (optionally), and a spin lock (spinlock 1010). Each ghost queue can have items (ghostFilters 1012) and a head 1014. Each ghost item 1012 can store a key 1016. In some embodiments, ghostQueues 706B can be an array of ghost queues providing ghost queues for multiple rows 812 of table 810. For example, each row 1008 of ghost table 1006 can store two, three, or four ghost queues for two, three, or four rows 812 of table 810, respectively.

For example, as shown in FIG. 9D, there can be 2²⁸ rows 812 in table 810. Each row 1008 in ghost table 1006 can store four ghost queues. In such an example, since each row 1008ₖ can provide ghost queues for four rows 812, then ghost table 1006 can include 2²⁸/4=2²⁶ rows. The 26 LSBs of the 28-bit cache entry index can be a ghost row index. The remaining two bits can be a ghost queue index to select among the four ghost queues. Each ghost queue includes a sequence of items, such as 10 items (ghostItems 1012), which is approximately 50% of 21 cache entries in a row 812 (e.g., with structure 900D). Each item can be a key 1016. Key 1016 can include less bits than key 920, e.g., key 920 can be hashed into another key 1016 having less bits (e.g., 21 bits to 11 bits). This can result in some amount of false positives (e.g., the ghost queues can be probabilistic). In C/C++ programming language notation, the structure for ghost queue can be specified as:

struct GhostItem {

unit64 key:11; // Hash 21-bit key into 11-bit key

};
struct GhostQueue {

GhostItem ghostItems[10]; // Approx. 50% of cache entries in a row 812
unit64 head:4;

};
struct GhostRow {

unit32 spinLock;
GhostQueue ghostQueues[4];
unit64 unused:24;

};

This structure for the ghost queue allows cache manager 410 to load a row of the ghost table into a cache line of CPU cache for use with multiple rows 812 of table 810, which can be in other cache lines of CPU.

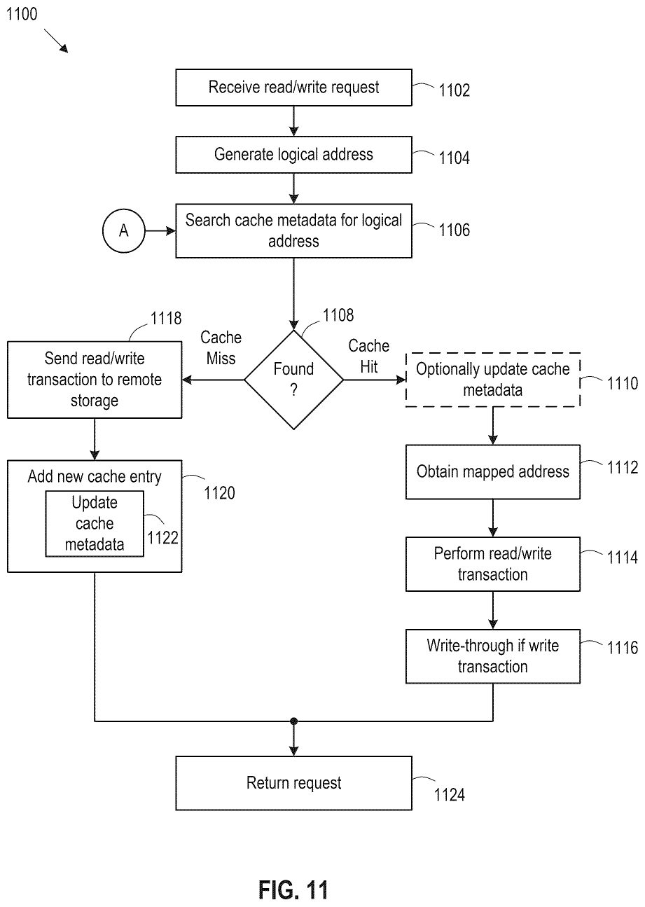

FIG. 11 is a flow diagram depicting a method 1100 of handling a read/write request at a client computer in cached remote storage system according to some embodiments. Method 1100 can begin a step 1102, where storage manager 22 can receive a read/write request from software executing in the computer. At step 1104, storage manager 22 can generate a logical address from the read/write request. For example, storage manager 22 can invoke cache address space manager 406 to generate logical address 408 from object UUID 402 and LBA 404. For example, the logical address can include OBJ_ID 422 and LBA 404. Other examples of a logical address are discussed below.

At step 1106, storage manager 22 can search cache metadata 32 for the logical address. At step 1108, storage manager 22 can determine if the logical address has been found in cache metadata 32. If so, a cache hit occurred. Method 1100 can proceed from step 1108 to step 1110. If not, a cache miss occurred. Method 1100 can proceed from step 1108 to step 1118.

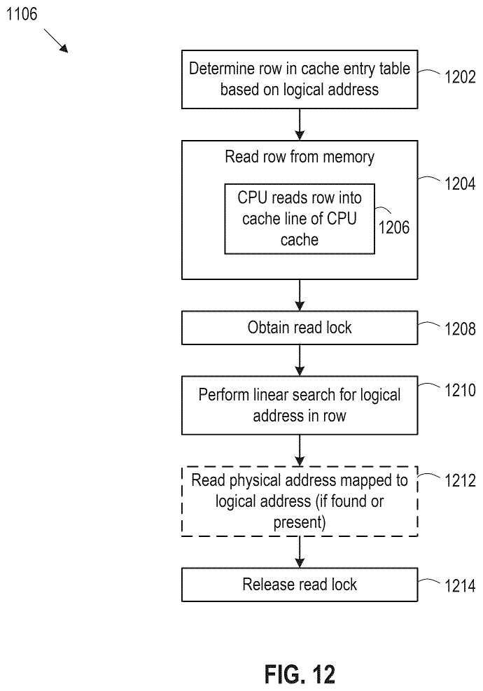

FIG. 12 is a flow diagram depicting a method of searching cache metadata 32 for a logical address according to some embodiments. The method can be performed during step 1106 of method 1100 shown in FIG. 11. At step 1202, storage manager 22 can determine a row in a cache entry table based on the logical address. For example, storage manager 22 can invoke cache manager 410 to select a row 812 in table 810 based on the logical address. As described above, in some embodiments, the logical address can be hashed to generate a key that is an index of a row 812 in table 810. In other embodiments, a portion of the logical address itself can be a key that is an index of a row 812 in table 810 (e.g., cache entry index as shown in FIG. 9D).

At step 1204, storage manager 22 can read the row of cache metadata 32 from memory 26. For example, cache manager 310 can execute an operation on CPU 24 to read the row from memory 26. CPU 24 can read the row into a cache line 50 of cache memory 34 (1206). As described in various embodiments above, the size of the row is such that the row fits in cache line 50. At step 1208, a thread 308 of storage manager 22 can obtain a read lock for the row of cache metadata 32. A read lock may be a condition that allows the thread to read the row without data corruption by other threads potentially writing to the row. At step 1210, thread 308 of storage manager 22 can perform a search for the logical address in the row (e.g., a linear search). Thread 308 can search through the cache entries in the row. Thread 308 can first search the hot queue and the cold queue. At step 1212, if the logical address was found, thread can read a physical address mapped to the logical address from the row. Step 1212 can be optional. In some embodiments described above, the row can store a physical address mapped to the logical address (e.g., FIG. 9A). In other embodiments, the row can omit storing the physical address to save space. Rather, the physical address can be derived from the offset into the row of the cache entry. In still other embodiments, the logical address can be directly mapped to a logical address space of an object management system and the notion of a physical address can be omitted (discussed further below). Thus, 1212 can be omitted in some embodiments. If the logical address was not found, step 1212 is not performed. At step 1214, thread 308 can release the read lock.

Returning to FIG. 11, consider the branch for a cache hit. At step 1110, storage manager 22 can optionally update cache metadata 32. Whether cache metadata 32 is updated in response to a cache hit can depend on the cache replacement algorithm in use (e.g., whether a reference bit needs to be set).

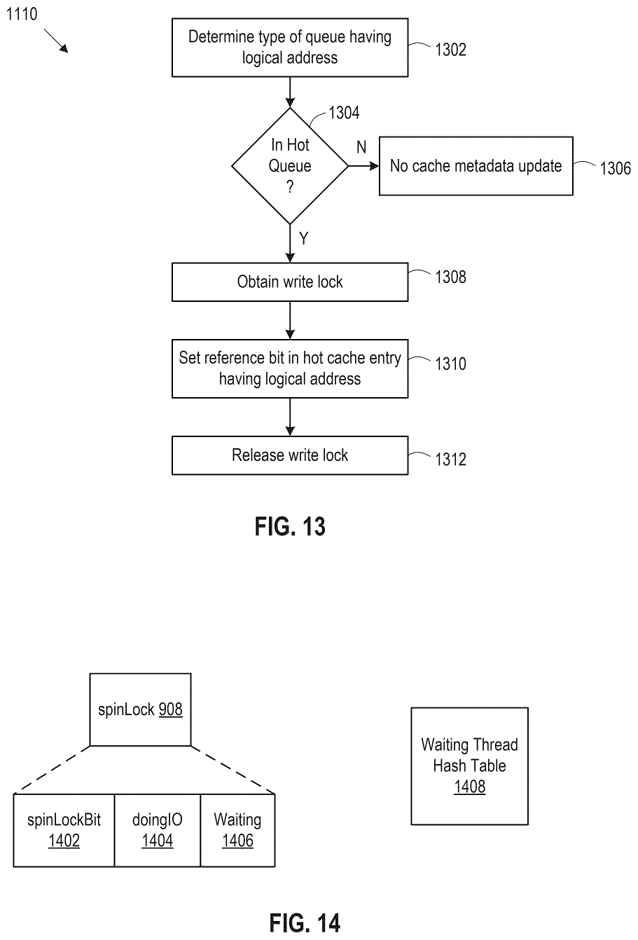

FIG. 13 is a flow diagram depicting a method of updating cache metadata 32 in response to a cache hit according to some embodiments. The method can be performed during step 1110 of method 1100 shown in FIG. 11. At step 1302, storage manager 22 can determine the type of queue in which the logical address was found. At step 1304, storage manager 22 can determine if the queue is the hot queue. If not, the method can proceed to step 1306, where no update to cache metadata 32 is performed. Otherwise, the method can proceed to step 1308, where a thread 308 of storage manager 22 can obtain a write lock. A write lock may be a condition that allows the thread to write to the row without data corruption by other threads potentially writing to the row. At step 1310, thread 308 can set a reference bit in the hot cache entry having the logical address. At step 1312, thread 308 can release the write lock. As described in some embodiments above, the cold queue can omit reference bits and thus the method in FIG. 13 can be performed. In other embodiments, the cold queue can include reference bits. In some cases, the reference bits can be set/cleared without affecting the algorithm. In other cases, (e.g., Clock2Q+), the reference bits are part of the algorithm. Thus, the method in FIG. 13 can be modified based on the cache replacement algorithm in use and whether cold entries include reference bits.

Returning to FIG. 11, method 1100 proceeds from step 1110 to step 1112, where storage manager 22 can obtain an address mapped to the logical address (mapped address). In some embodiments, the logical address is mapped to a physical address. In some embodiments, the physical address can be obtained from the cache entry storing the logical address. In other embodiments, the physical address can be derived from the offset of the cache entry storing the logical address. In other embodiments, the logical address can be mapped directly into a logical address space of a cache object managed by an object storage system (discussed further below). At step 1114, storage manager 22 can perform the read/write transaction with storage device(s) 28. At step 1116, storage manager 22 can write-through if the transaction is a write transaction (e.g., send the write transaction to the remote storage). At step 1124, storage manager 22 can send a return to the software issuing the read/write request. In case of cache miss at step 1108, method 1100 can proceed to step 1118. At step 1118, storage manager 22 can send the read/write transaction to remote storage.

FIG. 14 is a block diagram depicting concurrency data of cache metadata 32 according to some embodiments. In some embodiments, spinlock 908 in each row 812 of table 810 can include fields spinLockBit 1402, doingIO 1404, and waiting 1406. Each field can be one bit (3 bits total). The concurrency data can further include waiting thread hash table 1408 (e.g., part of overhead data 504). Use of waiting thread hash table 1408 is discussed below.

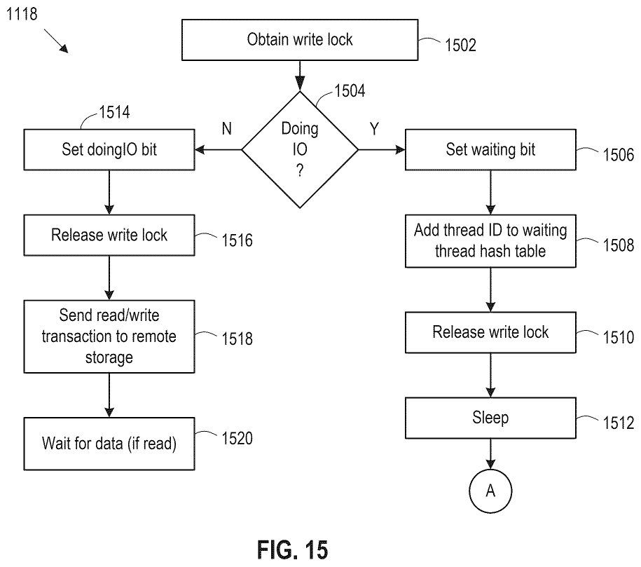

FIG. 15 is a flow diagram depicting a method of processing a cache miss according to some embodiments. The method can be performed in step 1118 of method 1100 of FIG. 11. The method begins at step 1502, where storage manager 22 obtains a write lock. At step 1504, a thread 308 of storage manager 22 determines if the doingIO bit is set. If so, the method proceeds to step 1506. This means that some other thread is doing IO. Thus, at step 1506, thread 308 can set the waiting bit to indicate that a thread is waiting. At step 1508, thread 308 can add its ID to waiting thread hash table 1408. At step 1510, thread 308 can release the write lock. At step 1512, thread 308 can sleep. After a sleep period, thread 308 can return to step 1106 and retry.

If at step 1504 the doingIO bit is clear, the method proceeds to step 1514. At step 1514, a thread 308 of storage manager 22 can set the doingIO bit. At step 1516, thread 308 can release the write lock. At step 1518, thread 308 can send the read/write transaction to the remote storage. At step 1520, thread 308 can wait for data to return (if it is a read transaction).

Returning to FIG. 11, at step 1120, storage manager 22 adds a new cache entry. At step 1122, while adding the new cache entry, storage manager 22 can update cache metadata 32. Method 1100 then proceeds to step 1124 and storage manager 22 sends a return for the request.

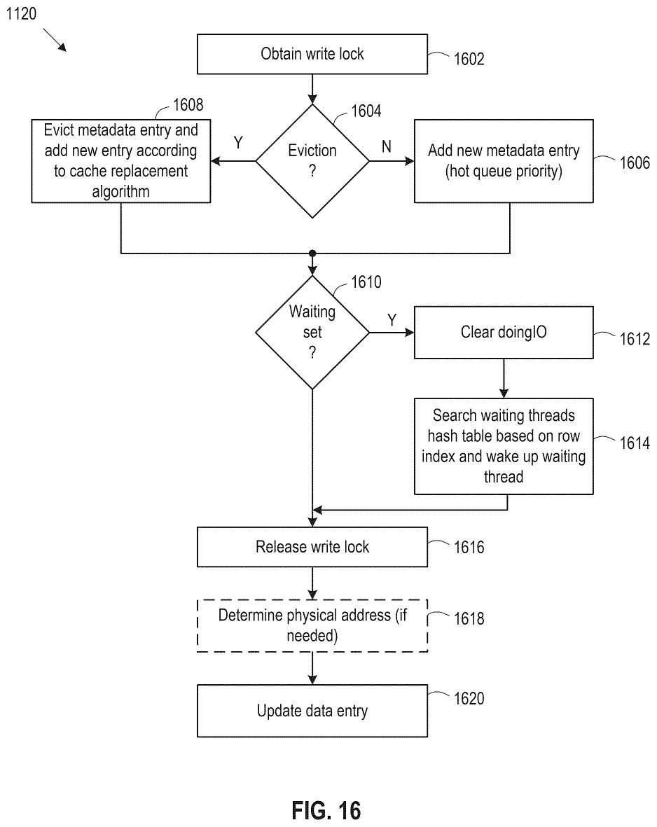

FIG. 16 is a flow diagram depicting a method of updating cache metadata 32 in response to a cache miss according to some embodiments. The method can be performed during step 1120 of method 1100 shown in FIG. 11. At step 1602, a thread 308 of storage manager 22 can obtain a write lock. At step 1604, thread 308 can determine if an entry needs to be evicted. If not, the method proceeds to step 1606, where thread 308 can add a new metadata entry (e.g., to the hot queue if not full, otherwise to the cold queue). The method proceeds to step 1610. If at step 1604 there is an eviction, the method proceeds to step 1608. At step 1608, thread 308 can evict a metadata entry and adds a new metadata entry according to the cache replacement algorithm in use. The method proceeds to step 1610.

At step 1610, thread 308 determines if the waiting bit is set. If so, the method proceeds to step 1612. This means that at least one other thread is waiting. At step 1612, thread 308 can clear the doingIO bit. At step 1614, thread 308 can search waiting threads hash table 1408 based on the row index and wakes up a waiting thread. The method proceeds to step 1616. If the waiting bit is clear at step 1610, the method proceeds to step 1616.

At step 1616, thread 308 can release the write lock. At optional step 1618, storage manager 22 can determine a physical address (in embodiments having a physical address). At step 1620, storage manager 22 can update the data entry for the cache.

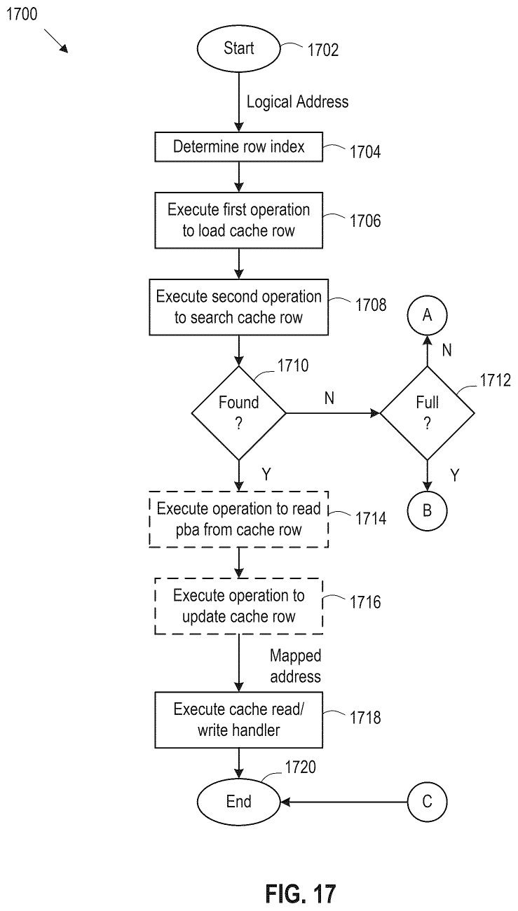

FIG. 17 is a flow diagram depicting a method 1700 summarizing storage cache lookup according to some embodiments. Method 1700 begins at step 1702. At step 1704, storage manager 22 can determine a row index in table 810 given a logical address 408. Different embodiments for this translation are described above. In some embodiments, storage manager 22 can hash logical address 408 into a row index. In other embodiments, storage manager 22 can use some bits of logical address 408 directly as an index into table 810 (e.g., as shown in view 950 of FIG. 9D). The selected row includes cache metadata for a partition of the key/value spaces. At step 1706, storage manager 22 can execute a first operation on CPU 24 to load a row 812 of table 810. Since row 812 has a width W less than or equal to the width of a cache line 50 in CPU 24, the row fits within one cache line 50. At step 1708, storage manager 22 can execute a second operation on CPU 24 to search the row (as stored in a cache line 50 of CPU 24) for logical address 408 or a key derived from logical address (e.g., a key 920 as shown in FIG. 9D). At step 1710, storage manager 22 can determine if the logical address/key has been found. If so (e.g., a cache hit), method 1700 proceeds to step 1714. Otherwise (e.g., a cache miss), method 1700 proceeds to step 1712.

At step 1714, storage manager 22 can execute an operation on CPU 24 to read a physical address (e.g., pba) from the row (as stored in cache line 50). In some embodiments, the cache entries omit storing a pba. In other embodiments, the logical address can be directly mapped into a logical address space of a cache object. In such cases, step 1714 is not executed (e.g., step 1714 is optional depending on the embodiment). At step 1716, storage manager 22 can execute an operation to update data in the row (as stored in cache line 50). Step 1716 is also optionally executed depending on the cache replacement algorithm in use and whether the logical address/key was found in a hot queue (where a reference bit needs to be updated) or a cold queue (e.g., no reference bit update). At step 1718, storage manager 22 can execute cache read/write handler 414 using a mapped address (e.g., physical address mapped to the logical address or the logical address itself). Method 1700 can end at step 1720. Notably, steps 1714 and/or 1716, if executed, may not require further memory transactions, as those operations can be performed using the row as cached by CPU 24.

At step 1712, storage manager 22 can determine if the partition of the cache represented by the selected row is full. If not, method 1700 can proceed to method 1800A or 1800B, as described below. If the partition of the cache is full, method 1700 can proceed to method 1900A, 1900B, 1900C, or 1900D, as described below.

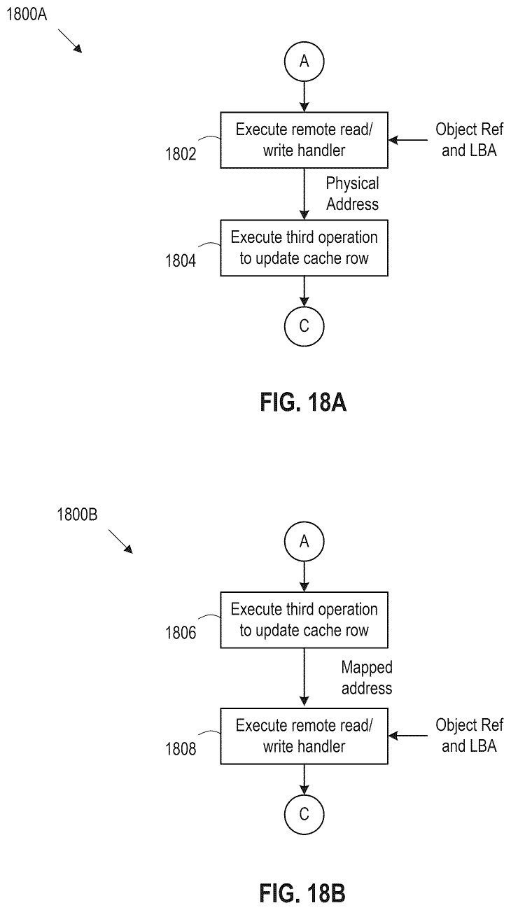

FIG. 18A is a flow diagram depicting a method 1800A of handling a cache miss when a partition of the cache is not full according to some embodiments. Method 1800A begins at step 1802, where storage manager 22 can execute remote read/write handler 416 using object UUID 402 and LBA 404 from read/write request 401. At step 1804, storage manager 22 can execute a third operation on CPU 24 to update data in the row (as stored in cache line 50). Storage manager 22 can obtain a physical address of a block where the cached data was stored from read/write handler 416. Storage manager 22 can update the data in the row by adding a cache entry (e.g., first to the hot queue and, if full, then to the cold queue). Step 1804 may not require any further memory transactions, as this operation can be performed using the row as cached by CPU 24. The embodiment of method 1800A can be used when the cache entries include the physical address. Method 1800A can return to method 1700 and end at step 1720.

FIG. 18B is a flow diagram depicting a method 1800B of handling a cache miss when a partition of the cache is not full according to other embodiments. Method 1800B begins at step 1806, where storage manager 22 can execute a third operation on CPU 24 to update data in the row (as stored in cache line 50). Storage manager 22 can update the data in the row by adding a cache entry (e.g., first to the hot queue and, if full, then to the cold queue). Step 1806 may not require any further memory transactions, as this operation can be performed using the row as cached by CPU 24. At step 1808, storage manager 22 can execute remote read/write handler 416 using object UUID 402 and LBA 404 from read/write request 401. Storage manager 22 can provide a mapped address to remote read/write handler 416 (e.g., a physical address or the logical address, depending on the embodiment). The embodiment of method 1800B can be used when the cache entries do not store the physical address. Method 1800B can return to method 1700 and end at step 1720.

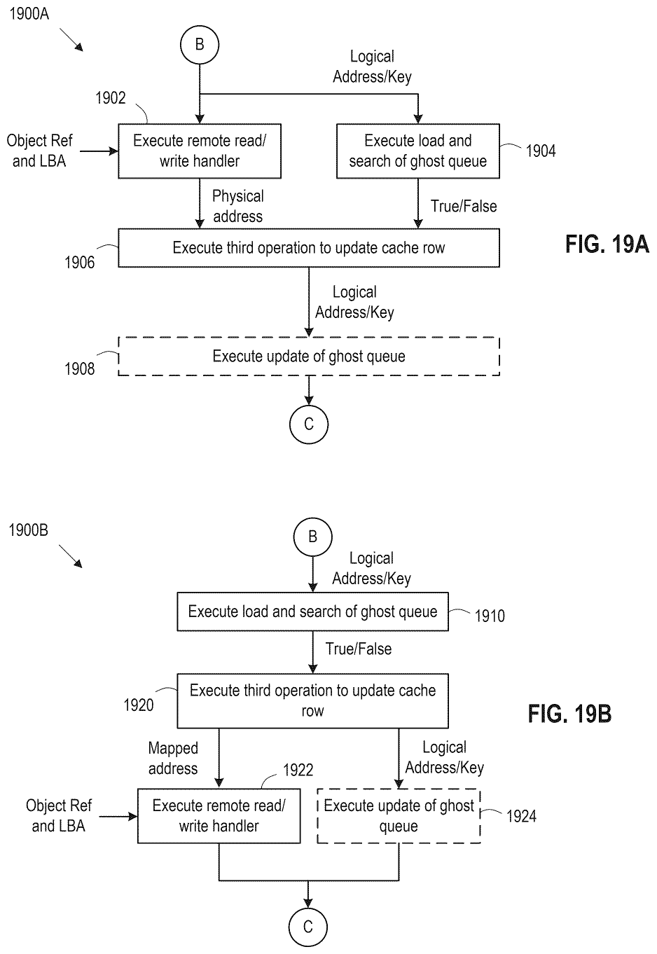

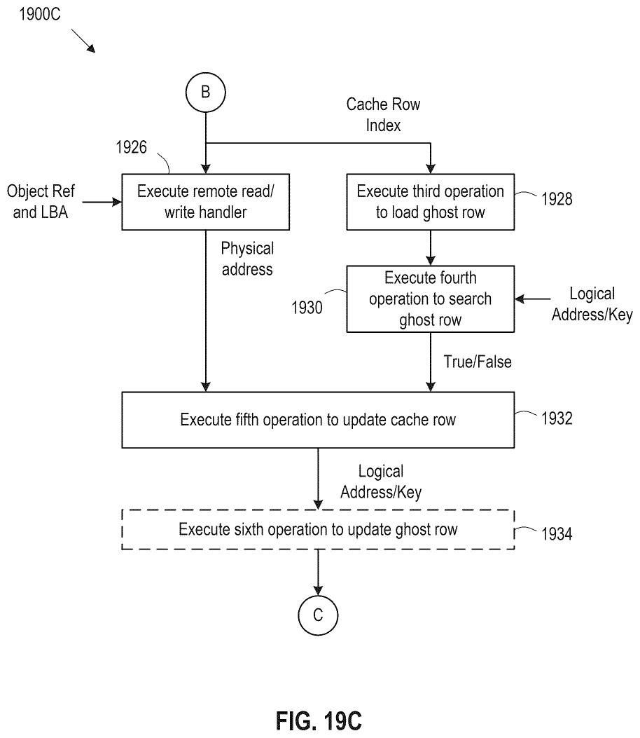

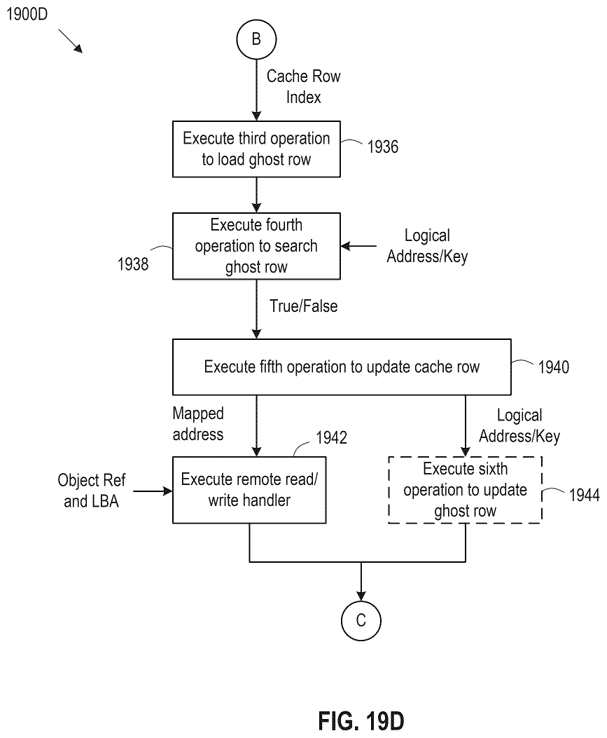

FIG. 19A is a flow diagram depicting a method 1900A of handling a cache miss when a partition of the cache is full according to some embodiments. At step 1902, storage manager 22 can execute remote read/write handler 416 using object UUID 402 and LBA 404 from read/write request 401. At step 1904, storage manager 22 can execute a load and search of a ghost queue (e.g., ghost queue 706 in FIG. 7A or ghost queue 706A in FIG. 10A). At step 1906, storage manager 22 can execute a third operation on CPU 24 to update the row (as stored in cache line 50). The cache update can include evicting a cache entry and adding a new cache entry based on the cache replacement algorithm. Step 1906 may not require any further memory transactions, as this operation can be performed using the row as cached by CPU 24. Storage manager 1906 can use the physical address (e.g., pba) from remote read/write handler 416 and a true/false indication from step 1904 indicating whether the logical address/key is present in the ghost queue when updating the data in the row. The embodiment of method 1900A can be used when the cache entries store the physical address (pba) and when the ghost queue is not partitioned into a table. At optional step 1908, storage manager 22 can execute an update of the ghost queue (e.g., an entry in the ghost queue added to the hot queue can be removed from the ghost queue or an entry evicted from the cold queue can be added to the ghost queue). Method 1900A can return to method 1700 and end at step 1720.

FIG. 19B is a flow diagram depicting a method 1900B of handling a cache miss when a partition of the cache is full according to other embodiments. Method 1900B can differ from method 1900A in that the cache entries do not store a physical address, but rather the physical address can be inferred from the offset of the cache entry being added or there is no physical address and the logical address is directly mapped. At step 1910, storage manager 22 can execute a load and search of a ghost queue (e.g., ghost queue 706 in FIG. 7A or ghost queue 706A in FIG. 10A). At step 1920, storage manager 22 can execute a third operation on CPU 24 to update the row (as stored in cache line 50). The cache update can include evicting a cache entry and adding a new cache entry based on the cache replacement algorithm. Step 1920 may not require any further memory transactions, as this operation can be performed using the row as cached by CPU 24. At step 1922, storage manager 22 can execute remote read/write handler 416 using object UUID 402 and LBA 404 from read/write request 401. Read/write handler 416 can receive the mapped address as input. At optional step 1924, storage manager 22 can execute an update of the ghost queue (e.g., an entry in the ghost queue added to the hot queue can be removed from the ghost queue or an entry evicted from the cold queue can be added to the ghost queue). Method 1900B can return to method 1700 and end at step 1720.

FIG. 19C is a flow diagram depicting a method 1900C of handling a cache miss when a partition of the cache is full according to other embodiments. Method 1900C differs from methods 1900A and 1900B in that the ghost queue is implemented using a ghost table as shown in FIG. 10B. At step 1926, storage manager 22 can execute remote read/write handler 416 using object UUID 402 and LBA 404 from read/write request 401. At step 1928, storage manager 22 can execute a third operation on CPU 24 to load a row 1008 from ghost table 1006 using the cache row index (e.g., the index into table 810). As discussed above, a row 1008 in ghost table 1006 can store multiple ghost queues for multiple rows of table 810. At step 1930, storage manager 22 can execute a fourth operation on CPU 24 to search ghost queue of the ghost row that is associated with the cache row. Storage manager 22 can search the appropriate ghost queue using the logical address or key. At step 1932, storage manager 22 can execute a fifth operation on CPU 24 to update the cache row based on a physical address (e.g., pba) received from remote read/write handler 416 and a true/false indication from searching the ghost queue. At step 1934, storage manager 22 can execute an update of the ghost queue in the ghost row (e.g., an entry in the ghost queue added to the hot queue can be removed from the ghost queue or an entry evicted from the cold queue can be added to the ghost queue). Method 1900C can return to method 1700 and end at step 1720.

FIG. 19D is a flow diagram depicting a method 1900D of handling a cache miss when a partition of the cache is full according to other embodiments. Method 1900D can be similar to method 1900C, except that the cache entries do not store the physical address. At step 1936, storage manager 22 can execute a third operation on CPU 24 to load a row 1008 from ghost table 1006 using the cache row index (e.g., the index into table 810). At step 1938, storage manager 22 can execute a fourth operation on CPU 24 to search ghost queue of the ghost row that is associated with the cache row. Storage manager 22 can search the appropriate ghost queue using the logical address or key. At step 1940, storage manager 22 can execute a fifth operation on CPU 24 to update the cache row based on a true/false indication from searching the ghost queue. At step 1942, storage manager 22 can execute remote read/write handler 416 using object UUID 402 and LBA 404 from read/write request 401. Remote read/write request handler 416 can receive the mapped address from step 1940. At step 1944, storage manager 22 can execute an update of the ghost queue in the ghost row (e.g., an entry in the ghost queue added to the hot queue can be removed from the ghost queue or an entry evicted from the cold queue can be added to the ghost queue). Method 1900D can return to method 1700 and end at step 1720.

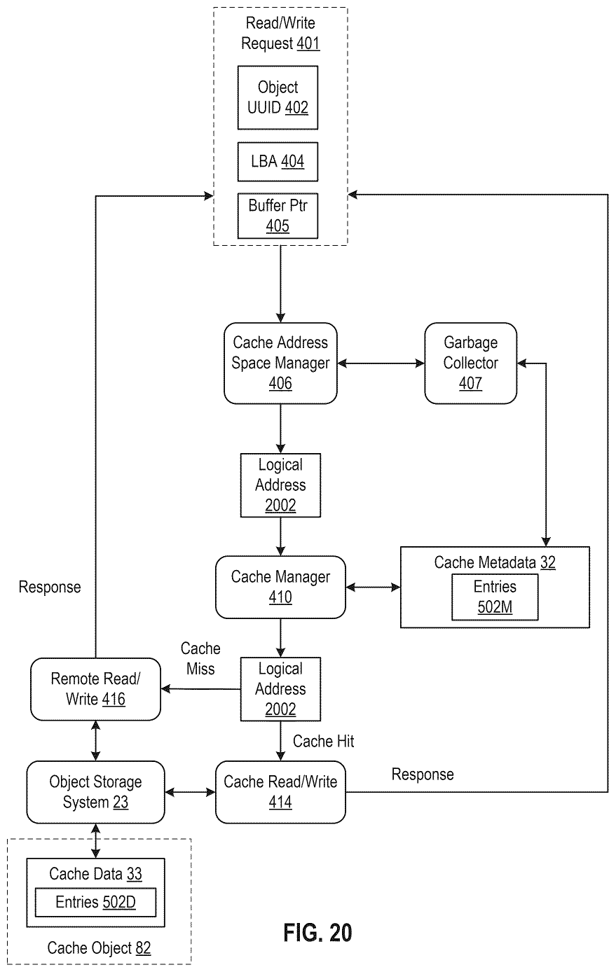

FIG. 20 is a block diagram depicting a logical view of caching remote storage at a computer according to some embodiments. The logical view in FIG. 20 is for where storage manager 22 cooperates with object storage system 23 to maintain cache data 33 in a cache object 82 managed by object storage system 23. Elements of FIG. 20 that are the same or similar to those of FIG. 4 are designated with identical reference numerals. Cache address space manager 406 can convert an object UUID 402 and LBA 404 into a logical address 2002. Logical address 2002 can be a logical address in a logical address space maintained by object storage system 23. Object storage system 23 can map logical addresses in the logical address space into physical addresses of a physical address space. Thus, cache metadata 32 can omit mapping logical addresses to physical addresses, such function being performed by object storage system 23. Rather, cache metadata 32 can be used for the function of tracking entries in the cache and determining cache hits and misses. In case of a cache miss, cache manager 410 can provide logical address 2002 to remote read/write 416. Remote read/write 416 can obtain object data (using object UUID 402 and LBA 404) from remote storage 20 and store the object data as entries 502D in a cache object 82 managed by object storage system 23. Remote read/write 416 can store send store requests to object storage system 23 using logical address 2002. In case of a cache hit, cache manager 410 can provide logical address 2002 to cache read/write 414. Cache read/write 414 can use logical address 2002 to request data from object storage system 23. Object storage system 23 can perform various functions for efficient storage of data on storage device(s) 28, such as data compression, data deduplication, wear control for SSDs, and the like. Cache manager 410, remote read/write 416, and cache read/write 414 can be agnostic to the physical storage and its management, instead interfacing with a logical address space of cache object 82.

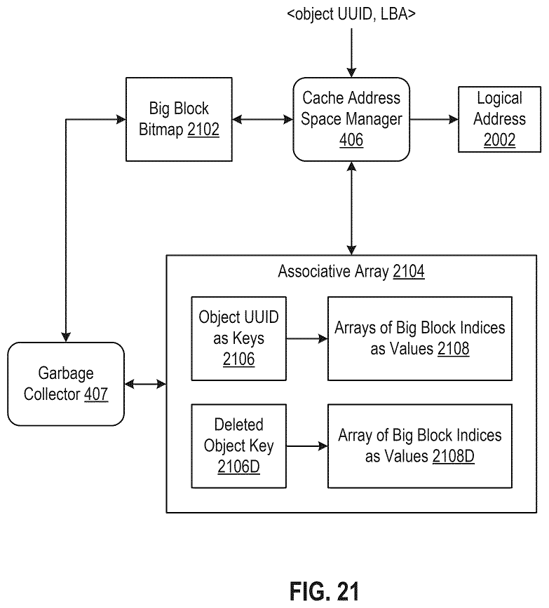

FIG. 21 is a block diagram depicting logical operation of cache address space manager 406 according to some embodiments. Cache address space manager 406 can map the larger address space <object UUID, LBA> into a smaller address space of cache object 82. For clarity and ease of explanation, assume in an example the logical address space of cache object 82 includes 2⁴⁰ addresses for corresponding blocks (e.g., approximately 4 PB of storage space). Cache address space manager 406 can divide the capacity of cache object 82 into units referred to herein as “big blocks.” In some embodiments, big blocks can be 16 GB in size (e.g., 2³⁴ bytes or 2⁽³⁴⁻¹²⁾=2²² four KB blocks). In this case, a 240-bit logical address space can address 2¹⁸ big blocks. Big blocks can have indices, e.g., a zero-based index from 0 to 2¹⁸−1. Cache address space manager 406 can maintain a big block bitmap 2102 that includes a bit for each big block index, which indicates whether that big block has been allocated. Cache address space manager 406 can maintain an associative array 2104 (e.g., using a hash table or the like) that maps object UUIDs to arrays of big block indices (e.g., keys 2106 to values 2108). One key 2106D can be reserved for mapping to an array of deleted big block indices (e.g., key 2106D to value 2108D).

In operation, when cache address space manager 406 receives <obj UUID, LBA>, cache address space manager 406 can lookup the object UUID in associative array 2104. If the object UUID is not present, cache address space manager 406 can allocate one or more big blocks to the object depending on the LBA. For example, if LBA<16 GB, then cache address space manager 406 can allocate one big block. If LBA>16 GB, then cache address space manager 406 can perform integer division of LBA/16 and determine the number of big blocks needed for that object. Since a given <objUUID, LBA> only refers to one 4 KB block, cache address space manager 406 can perform a sparse allocation. For example, a transaction with <objUUID-0, 10 GB> can map objUUID-0 to an array [BigBlock0]. Next, a transaction with <objUUID-1, 25 GB> can map objUUID-1 to an array [−1, BigBlock1], where −1 is a place holder in the sparse allocation. Next, a transaction with <objUUID-1, 5 GB> can map objUUID-1 to an array [BigBlock3, BigBlock1], replacing the sparse placeholder. Cache address space manager 406 can obtain indices of the big blocks available to be allocated from big block bitmap 2102. Given an array of big block indices for a given objectUUID, cache address space manager 406 can determine logical address as follows: 1) BigBlockIndex=array_of_big_block_indices [LBA/16 GB]; 2) offset_within_big_block=LBA % 16 GB; and 3) logical address=BigBlockIndex*16 GB+offset_within_big_block.

When an object is deleted, the index(s) for the big block(s) allocated for its objectUUID can be added to the array 2108D mapped to deleted object key 2106D. Garbage collector 407 can periodically process array 2108D to identify big blocks to be released from the cache. Garbage collector 407 can parse cache metadata 32 (e.g., hot queues, cold queues, ghost queues) to remove entries with any logical addresses mapped to each big block to be released. Garbage collector 407 can then clear the bits in big block bitmap 2102 so that the big blocks can be relocated.

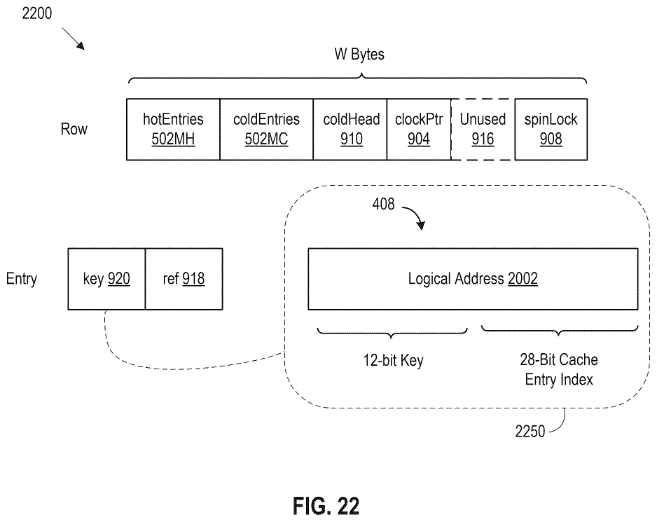

After generation of logical address 2002, the cache lookup and update process can proceed as described in the various embodiments above (e.g., FIGS. 11-19). Logical address 2002 can be directly mapped into the logical address space of cache object 82 so the metadata can omit storing a physical address. An embodiment of metadata structure similar to that shown in FIG. 9D can be used, as described below with respect to FIG. 22.

FIG. 22 is a block diagram depicting a cache metadata structure 2200 according to further embodiments. Elements of FIG. 22 that are the same or similar to FIG. 9D are designated with identical reference numerals. The structure of row 812 in structure 2200 is the same as in 900C. However, the entry structure can be changed to include fields for key 920 and ref 918. Consider cache configuration of Example 5D and address configuration where logical address 2002 is 40 bits. Table 810 can include 2²⁸ rows 812 (e.g., S=2²⁸). Rows 812 can be identified by index (e.g., a zero-based index between 0 and S−1). This index can be referred to as a cache entry index. As shown in view 2250, the 28 LSBs of logical address 2002 can be used as a cache entry index to select a row in table 810. The remaining MSBs (e.g., 12 bits in case of a 40-bit logical address) make a 12-bit key. The field key 920 in each entry can include storage for such a 12-bit key. In C/C++ programming language notation, structure 2200 can be specified as:

struct Entry {

// Structure for Example 5D and 40-bit logical address
unit64 key:12;
unit64 ref:1;

};
Struct TableRow {

struct Entry hotEntries[32]; // Total of 32 hot entries 502MH
struct Entry coldEntries[4]; // Total of 4 cold entries 502MC
unit64 coldHead:2;
unit64 clockPtr:5;
unit64 unused:5;
unit32 spinLock;

};

In the example data structures Entry and TableRow, the total size of TableRow is 64 bytes (e.g., W=64 bytes). Since there are 36 entries 502M per row 812, table 810 can consume 64/36 bytes per entry. Cache metadata 32 can include additional overhead data 504 not present in table 810, which includes the ghost FIFO. The ghost FIFO can be implemented as shown in FIG. 10B, where each row in the ghost table can store three ghost queues for a corresponding three rows of table 810. In C/C++ programming language notation, the structure for ghost queue can be specified as:

struct GhostItem {

unit64 key:12;

};
struct GhostQueue {

GhostItem ghostItems[12]; // Approx. 33% of cache entries in a row 812
unit64 head:4;

};
struct GhostRow {

unit32 spinLock;
GhostQueue ghostQueues[3];
unit64 unused:36;

};

Thus, in such an embodiment, cache metadata 32 can consume 64/36*1.33=2.37 bytes per cache entry.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items. By way of example, the phrases “at least one of A, B, and C” or “at least one of A, B, or C” each refer to only A, only B, or only C; and/or any combination of A, B, and C. In instances where it is intended that a selection be of “at least one of each of A, B, and C,” or alternatively, “at least one of A, at least one of B, and at least one of C,” it is expressly described as such.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

As used herein, the term “couple” or “connect” and its derivatives include: (a) electrical and communicative coupling; and (b) do not imply a direct connection, but rather may include intervening elements, unless described as “directly coupled” or “directly connected.”

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

1. A computer, comprising:
a hardware platform including a memory, a central processing unit (CPU) having a first cache for the memory, and a storage device, the storage device configured to store a second cache for a remote storage system accessible by the computer over a network;
first software executing on the hardware platform and configured to maintain metadata in the memory for the second cache, the metadata including a table having rows, each of the rows controlling multiple entries in the second cache, each of the rows having a first size, the first size less than or equal to a second size of entries in the first cache; and
second software executing on the hardware platform and configured to issue a read or write transaction for an object managed by the remote storage system, the transaction indicating a first address:
wherein the first software is configured to:
execute, in response to the first address, a first operation on the CPU to read a first row of the rows from the memory to a first entry of the entries in first cache;
execute a second operation on the CPU to search the first row as stored in the first cache for the first address;
perform the transaction, based on a result of the second operation, to read from or write to the storage device.

2. The computer of claim 1, wherein the result of the second operation is that the first address is in the first row, and wherein the first software is configured to:
execute a third operation on the CPU to update data in the first row.

3. The computer of claim 1, wherein the result of the second operation is that the first address is not in the first row, and wherein the first software is configured to:
execute a third operation on the CPU to update data in the first row.

4. The computer of claim 3, wherein the metadata includes another table having rows, each of the rows including multiple queues and having a third size less than or equal to the second size of the entries in the first cache, and wherein the first software is configured to:
execute a fourth operation on the CPU to read a first row of the other table from the memory to a second entry of the entries in the first cache; and
execute a fifth operation on the CPU to search the first row of the other table as stored in the first cache for the first address.

5. The computer of claim 4, wherein the first software is configured to:
execute a sixth operation on the CPU to update data of the first row of the other table.

6. The computer of claim 1, wherein the result of the second operation includes a second address for a block of the storage device, and wherein the first software is configured to perform the transaction using the second address.

7. The computer of claim 1, wherein the result of the second operation includes a second address for an object managed by an object storage system, and wherein the first software is configured to perform the transaction using the second address.

8. A method of reading from a remote storage system at a computer, the computer comprising hardware platform that includes a memory, a central processing unit (CPU) having a first cache for the memory, and a storage device, the storage device configured to store a second cache for the remote storage system accessible by the computer over a network, the method comprising:
maintaining, by first software executing on the hardware platform, metadata in the memory for the second cache, the metadata including a table having rows, each of the rows controlling multiple entries in the second cache, each of the rows having a first size, the first size less than or equal to a second size of entries in the first cache;
issuing, by second software executing on the hardware platform, a read or write transaction for an object managed by the remote storage system, the transaction indicating a first address;
executing, by the first software in response to the first address, a first operation on the CPU to read a first row of the rows from the memory to a first entry of the entries in first cache;
executing, by the first software, a second operation on the CPU to search the first row as stored in the first cache for the first address; and
performing, by the first software, the transaction based on a result of the second operation to read or write from the storage device.

9. The method of claim 8, wherein the result of the second operation is that the first address is in the first row, and wherein the method comprises:
executing, by the first software, a third operation on the CPU to update data in the first row.

10. The method of claim 8, wherein the result of the second operation is that the first address is not in the first row, and wherein the method comprises:
executing, by the first software, a third operation on the CPU to update data in the first row.

11. The method of claim 10, wherein the metadata includes another table having rows, each of the rows including multiple queues and having a third size less than or equal to the second size of the entries in the first cache, and wherein the method comprises:
executing, by the first software, a fourth operation on the CPU to read a first row of the other table from the memory to a second entry of the entries in the first cache; and
executing, by the first software, a fifth operation on the CPU to search the first row of the other table as stored in the first cache for the first address.

12. The method of claim 11, further comprising:
executing, by the first software, a sixth operation on the CPU to update data of the first row of the other table.

13. The method of claim 8, wherein the result of the second operation includes a second address for a block of the storage device, and wherein the first software is configured to perform the transaction using the second address.

14. The method of claim 8, wherein the result of the second operation includes a second address for an object managed by an object storage system, and wherein the first software is configured to perform the transaction using the second address.

15. A non-transitory computer readable medium comprising instructions to be executed in a computing device to cause the computing device to carry out a method of reading from a remote storage system at a computer, the computer comprising hardware platform that includes a memory, a central processing unit (CPU) having a first cache for the memory, and a storage device, the storage device configured to store a second cache for the remote storage system accessible by the computer over a network, the method comprising:
maintaining, by first software executing on the hardware platform, metadata in the memory for the second cache, the metadata including a table having rows, each of the rows controlling multiple entries in the second cache, each of the rows having a first size, the first size less than or equal to a second size of entries in the first cache;
issuing, by second software executing on the hardware platform, a read or write transaction for an object managed by the remote storage system, the transaction indicating a first address;
executing, by the first software in response to the first address, a first operation on the CPU to read a first row of the rows from the memory to a first entry of the entries in first cache;
executing, by the first software, a second operation on the CPU to search the first row as stored in the first cache for the first address; and
performing, by the first software, the transaction based on a result of the second operation to read or write from the storage device.

16. The non-transitory computer readable medium of claim 15, wherein the result of the second operation is that the first address is in the first row, and wherein the method comprises:
executing, by the first software, a third operation on the CPU to update data in the first row.

17. The non-transitory computer readable medium of claim 15, wherein the result of the second operation is that the first address is not in the first row, and wherein the method comprises:
executing, by the first software, a third operation on the CPU to update data in the first row.

18. The non-transitory computer readable medium of claim 17, wherein the metadata includes another table having rows, each of the rows including multiple queues and having a third size less than or equal to the second size of the entries in the first cache, and wherein the method comprises:
executing, by the first software, a fourth operation on the CPU to read a first row of the other table from the memory to a second entry of the entries in the first cache; and
executing, by the first software, a fifth operation on the CPU to search the first row of the other table as stored in the first cache for the first address.

19. The non-transitory computer readable medium of claim 15, wherein the result of the second operation includes a second address for a block of the storage device, and wherein the first software is configured to perform the transaction using the second address.

20. The non-transitory computer readable medium of claim 15, wherein the result of the second operation includes a second address for an object managed by an object storage system, and wherein the first software is configured to perform the transaction using the second address.
